(19) United States
(12) Patent Application Publication
(10) Pub. No.: US 2026/0261366 A1
(43) Pub. Date: Sep. 3, 2026

(54) COMMUNICATION METHOD AND APPARATUS

(71) Applicant: HUAWEI TECHNOLOGIES CO., LTD., Shenzhen (CN)

(72) Inventors: Qi Feng, Shanghai (CN); Fan Wang, Shanghai (CN)

(73) Assignee: HUAWEI TECHNOLOGIES CO., LTD., Shenzhen (CN)

(21) Appl. No.: 19/655,359

(22) Filed: Apr. 22, 2026

Related U.S. Application Data
(63) Continuation of application No. PCT/CN2023/126619, filed on Oct. 25, 2023.

(51) Int. Cl. H04L 1/1607; H04L 27/28; H04L 43/0864; H04W 74/0833

(52) U.S. Cl. CPC H04L 1/1642; H04L 27/28; H04L 43/0864; H04W 74/0833

(57) ABSTRACT

A terminal device determines a first physical root sequence based on a first logical root sequence number and a mapping relationship between a logical root sequence number and a physical root sequence number, and sends a first sequence. A network device determines the first physical root sequence based on the first logical root sequence number and the mapping relationship between the logical root sequence number and the physical root sequence number, and receives the first sequence based on the first logical root sequence number. The first sequence is determined based on the first physical root sequence, and belongs to a first physical root sequence set. The first physical root sequence set corresponds to a same cubic metric interval, a same maximum round-trip delay interval, and a same maximum Doppler frequency shift interval.

### CROSS-REFERENCE TO RELATED APPLICATIONS

This application is a continuation of International Application No. PCT/CN2023/126619, filed on Oct. 25, 2023, the disclosure of which is hereby incorporated by reference in its entirety.

### TECHNICAL FIELD

This application relates to the field of communication technologies, and specifically, to a communication method and apparatus.

### BACKGROUND

In systems such as long term evolution (long term evolution, LTE) and new radio (new radio, NR), a reference signal and a random access preamble are both generated based on a root sequence. Sequence numbers of a plurality of root sequences are divided into a plurality of root sequence number sets, and different root sequence number sets may be allocated to different cells. Currently, a same root sequence number set supports a plurality of different maximum moving speeds, and sequence resource utilization is low.

### SUMMARY

Embodiments of this application provide a communication method and apparatus, to improve sequence resource utilization.

To achieve the foregoing objective, the following technical solutions are used in embodiments of this application.

According to a first aspect, an embodiment of this application provides a communication method that may be performed by a first communication apparatus. The first communication apparatus may be a terminal device, or the first communication apparatus is a component configured to implement a function of the terminal device. For example, the first communication apparatus is a unit/module, a circuit, a chip, or the like in the terminal device. The following describes the method provided in the first aspect by using an example in which the first communication apparatus is the terminal device.

The communication method includes: The terminal device determines a first physical root sequence based on a first logical root sequence number and a mapping relationship between a logical root sequence number and a physical root sequence number, and sends a first sequence. The first sequence is determined based on the first physical root sequence, the first physical root sequence belongs to a first physical root sequence set, and root sequences in the first physical root sequence set correspond to a same cubic metric interval, a same maximum round-trip time interval, and a same maximum Doppler frequency shift interval.

Correspondingly, according to a second aspect, an embodiment of this application provides a communication method that may be performed by a second communication apparatus. The second communication apparatus may be a network device, or the second communication apparatus is a component configured to implement a function of the network device. For example, the second communication apparatus is a unit/module, a circuit, a chip, or the like in the network device. The following describes the method provided in the second aspect by using an example in which the second communication apparatus is the network device.

The communication method includes: The network device receives a first sequence, and determines the first sequence based on a mapping relationship between a logical root sequence number and a physical root sequence number and a first logical root sequence number. The first logical root sequence number indicates a first physical root sequence, and the first sequence is determined based on the first physical root sequence. The first physical root sequence belongs to a first physical root sequence set, and root sequences in the first physical root sequence set correspond to a same cubic metric interval, a same maximum round-trip time interval, and a same maximum Doppler frequency shift interval.

In the method provided in the first aspect and the second aspect, the root sequences in the first physical root sequence set correspond to the same cubic metric interval, the same maximum round-trip time interval, and the same maximum Doppler frequency shift interval. Because the root sequences in the first physical root sequence set correspond to the same maximum Doppler frequency shift interval, even if the terminal device moves at a high speed, a sequence available to the terminal device in the first physical root sequence set does not jump. In other words, all physical root sequences in the first physical root sequence set are available to the terminal device. It may be understood that, if root sequences in a physical root sequence set correspond to a plurality of maximum Doppler frequency shift intervals, when the terminal device moves at a high speed, there is inevitably a root sequence unavailable to the terminal device in the physical root sequence set. Therefore, in embodiments of this application, the root sequences in the first physical root sequence set correspond to the same maximum Doppler frequency shift interval, so that sequence utilization can be improved.

According to a third aspect, an embodiment of this application provides a communication method that may be performed by a communication apparatus. The communication apparatus may be a terminal device, or a component configured to implement a function of the terminal device. For example, the communication apparatus is a unit/module, a circuit, a chip, or the like in the terminal device. Alternatively, the communication apparatus may be a network device, or a component configured to implement a function of the network device. For example, the communication apparatus is a unit/module, a circuit, a chip, or the like in the network device.

The communication method includes: The communication apparatus sorts all physical root sequence numbers, and sets a logical root sequence number for each sorted physical root sequence number, to obtain a mapping relationship between the logical root sequence number and the physical root sequence number. a plurality of consecutive physical root sequence numbers in all the physical root sequence numbers each correspond to a same cubic metric interval, a same maximum round-trip time interval, and a same maximum Doppler frequency shift interval. The logical root sequence number is a position index of the corresponding physical root sequence number in all the physical root sequence numbers.

The third aspect essentially provides a method for mapping the logical root sequence number to the physical root sequence number. Based on the mapping method, the plurality of consecutive physical root sequence numbers in all the physical root sequence numbers each correspond to the same cubic metric interval, the same maximum round-trip time interval, and the same maximum Doppler frequency shift interval. According to the method provided in the third aspect, sequence utilization can be improved, and the method is especially applicable to a high-speed movement scenario.

In an implementation of the first aspect, the method further includes: The terminal device sorts all physical root sequence numbers, and sets a logical root sequence number for each sorted physical root sequence number, to obtain a mapping relationship between the logical root sequence number and the physical root sequence number. a plurality of consecutive physical root sequence numbers in all the physical root sequence numbers each correspond to a same cubic metric interval, a same maximum round-trip time interval, and a same maximum Doppler frequency shift interval. The logical root sequence number is a position index of the corresponding physical root sequence number in all the physical root sequence numbers.

The terminal device may obtain the mapping relationship between the logical root sequence number and the physical root sequence number by using the method for mapping the logical root sequence number to the physical root sequence number provided in the third aspect, to determine, based on the mapping relationship, the physical root sequence to be used to send the first sequence. Based on the mapping method, all physical root sequences in each physical root sequence set are available to the terminal device, so that sequence utilization is high. In an implementation, the mapping relationship is (pre) configured.

In an implementation of the second aspect, the method further includes: The network device sorts all physical root sequence numbers, and sets a logical root sequence number for each sorted physical root sequence number, to obtain a mapping relationship between the logical root sequence number and the physical root sequence number. a plurality of consecutive physical root sequence numbers in all the physical root sequence numbers each correspond to a same cubic metric interval, a same maximum round-trip time interval, and a same maximum Doppler frequency shift interval. The logical root sequence number is a position index of the corresponding physical root sequence number in all the physical root sequence numbers.

The network device obtains the mapping relationship between the logical root sequence number and the physical root sequence number by using the method for mapping the logical root sequence number to the physical root sequence number provided in the third aspect, to determine, based on the mapping relationship, the first sequence received from the terminal device. In an implementation, the mapping relationship is (pre) configured.

In an implementation of the third aspect, the communication apparatus is a terminal device, and the method further includes: The terminal device determines a first physical root sequence number based on a first logical root sequence number of a cell and the mapping relationship, where the first physical root sequence number indicates a first physical root sequence; and sends a first sequence, where the first sequence is generated based on the first physical root sequence.

Correspondingly, in an implementation of the third aspect, the communication apparatus is a network device, and the method further includes: The network device determines a first physical root sequence number based on a first logical root sequence number of a cell and the mapping relationship, where the first physical root sequence number indicates a first physical root sequence; and receives a first sequence based on the first physical root sequence number, where the first sequence is generated based on the first physical root sequence.

In an implementation of the first aspect or the third aspect, the communication apparatus is a terminal device, and the method further includes: The terminal device receives indication information, where the indication information indicates the first logical root sequence number, and the first logical root sequence number indicates a sequence number of the first physical root sequence.

Correspondingly, in an implementation of the second aspect or the third aspect, the communication apparatus is a network device, and the method further includes: The network device sends indication information, where the indication information indicates the first logical root sequence number, and the first logical root sequence number indicates a sequence number of the first physical root sequence.

The network device may send the first logical root sequence number to a terminal device, so that the first logical root sequence number is aligned between the terminal device and the network device, and the network device correctly parses the first sequence received from the terminal device.

In an implementation of any one of the first aspect to the third aspect, all the physical root sequence numbers are divided into a plurality of physical root sequence number sets, and the plurality of physical root sequence number sets are obtained according to the following division rule:
dividing all the physical root sequence numbers into a low cubic metric group and a high cubic metric group by using a first cubic metric as a boundary, where cubic metrics of physical root sequences indicated by all physical root sequence numbers in the low cubic metric group do not exceed the first cubic metric, and cubic metrics of physical root sequences indicated by all physical root sequence numbers in the high cubic metric group exceed the first cubic metric;
for the low cubic metric group and the high cubic metric group, dividing all physical root sequence numbers in each group into a plurality of physical root sequence number sets by using a maximum round-trip time and a maximum Doppler frequency shift as a boundary; and
arranging physical root sequence numbers in each of the plurality of physical root sequence number sets in a cubic metric order.

In an implementation of any one of the first aspect to the third aspect, arranging the physical root sequence numbers in each of the plurality of physical root sequence number sets in the cubic metric order includes: first sorting physical root sequence number sets in the low cubic metric group, and then sorting physical root sequence number sets in the high cubic metric group; for the low cubic metric group, performing, starting from a last physical root sequence number set, alternate arrangement in ascending and descending order of cubic metrics, where arrangement is performed in the last physical root sequence number set in ascending order of cubic metrics; and for the high cubic metric group, performing, starting from a first physical root sequence number set, alternate arrangement in ascending and descending order of cubic metrics, where arrangement is performed in the first physical root sequence number set in ascending order of cubic metrics.

This solution provides a manner of dividing and sorting all the physical root sequence numbers, so that all physical root sequence numbers in each physical root sequence number set correspond to a same cubic metric interval, a same maximum round-trip time interval, and a same maximum Doppler frequency shift interval. Therefore, within a specific cell radius and a specific moving speed, mutual interference between any two sequences available to the terminal device is small, and sequence utilization is high.

In an implementation of any one of the first aspect to the third aspect, the method further includes: determining a candidate peak point of an ambiguity function of a physical root sequence corresponding to each physical root sequence number. In a delay-Doppler coordinate system, the candidate peak point satisfies the following: a delay spacing between the candidate peak point and a coordinate origin in the delay-Doppler coordinate system is not greater than a delay spacing between the coordinate origin and any peak point other than the coordinate origin; and/or a Doppler spacing between the candidate peak point and the coordinate origin in the delay-Doppler coordinate system is not greater than a Doppler spacing between the coordinate origin and the any peak point other than the coordinate origin. A horizontal axis in the delay-Doppler coordinate system indicates delay domain, and a vertical axis in the delay-Doppler coordinate system indicates Doppler domain.

In this solution, for all peak points of an ambiguity function of a root sequence in a specified area, if a delay spacing between a peak point and the coordinate origin is not greater than a delay spacing between the coordinate origin and any peak point other than the coordinate origin in the delay-Doppler coordinate system and/or a Doppler spacing between the peak point and the coordinate origin is not greater than a Doppler spacing between the coordinate origin and the any peak point other than the coordinate origin in the delay-Doppler coordinate system, the peak point is determined as the candidate peak point, so that a final peak point corresponding to the root sequence is determined from candidate peak points. According to this solution, the root sequence corresponding to the finally selected peak point may correspond to a larger maximum round-trip time interval and/or a larger maximum Doppler frequency shift interval as much as possible, in other words, a maximum cell radius and/or a maximum moving speed supported by the root sequence corresponding to the finally selected peak point are/is as large as possible.

In an implementation of any one of the first aspect to the third aspect, a set [symbol] ={ [symbol] , [symbol] , . . . , [symbol] } of coordinates of candidate peak points of the ambiguity function satisfies the following:

$$𝒮 = \{ 〈 τ , u τ mod N 〉 \vert min \{ \pm u τ mod N \} < {min}_{n = 1 , 2 , … , τ - 1} \{ \pm u τ mod N \} , τ ∈ \{ 1 , 2 , … , ( N - 1 ) / 2 \} \}$$

N indicates a sequence length of the first physical root sequence, u indicates the first physical root sequence number, τᵢ indicates a delay coordinate of an i^{th} candidate peak point in the set [symbol] of the coordinates of the candidate peak points of the ambiguity function, vᵢ indicates a Doppler coordinate of the i^{th} candidate peak point in the set S of the coordinates of the candidate peak points of the ambiguity function, 0≤i≤| [symbol] |−1, and the operator |·| indicates cardinality of the set. In ±uτ mod N, a positive/negative operation is performed first, and then a modulo operation is performed. In ±un mod N, a positive/negative operation is performed first, and then a modulo operation is performed.

In an implementation of any one of the first aspect to the third aspect, the method further includes: determining an i^{th} candidate physical root sequence number set Δ_{T,k}_{ᵢ}×Δ_{F,l}_{ᵢ} based on coordinates [symbol] of the i^{th} candidate peak point in the set [symbol] ; and determining, based on each candidate physical root sequence number set, a physical root sequence number set [Δ_{T,k}, Δ_{T,k+1})×[Δ_{F,l}, Δ_{F,l+1}) corresponding to the physical root sequence number, where k∈{0,1, . . . K−1}, l∈{0,1, . . . L−1}. A maximum round-trip time interval [Δ_{T,k}_{ᵢ}, Δ_{T,k}_{ᵢ}₊₁) and a maximum Doppler frequency shift interval [Δ_{F,l}_{ᵢ}, Δ_{F,l}_{ᵢ}₊₁) that correspond to Δ_{T,k}_{ᵢ}×Δ_{F,l}_{ᵢ} satisfy the following:

$${τ}_{i} \times min \{ {ν}_{i} , N - {ν}_{i} \} ∈ [ {Δ}_{T , {k}_{i}} , {Δ}_{T , {k}_{i} + 1} ) \times [ {Δ}_{F , {l}_{i}} , {Δ}_{F , {l}_{i} + 1} )$$

[Δ_{T,0}, Δ_{T,1}), [Δ_{T,1}, Δ_{T,2}), . . . , [Δ_{T,K-1}, +∞) indicates K preset maximum round-trip time intervals in the physical root sequence number set, [Δ_{F,0}, Δ_{F,1}), [Δ_{F,1}, Δ_{F,2}), . . . [Δ_{F,L-1}, +∞) indicates L preset maximum Doppler frequency shift intervals in the physical root sequence number set, 0≤kᵢ≤K−1, 0≤lᵢ≤L−1, and 0≤i≤| [symbol] |−1.

In this solution, the candidate peak points are mapped to a two-dimensional plane on which the delay-Doppler coordinate system is located, and the mapped candidate peak points are sorted, to obtain [Δ_{T,k}, Δ_{T,k+1})×[Δ_{F,l}, Δ_{F,l+1}).

In an implementation of any one of the first aspect to the third aspect, each physical root sequence number may be mapped to a corresponding physical root sequence number set [Δ_{T,k}, Δ_{T,k+1})×[Δ_{F,l}, Δ_{F,l+1}) according to a specific rule, to ensure that all root sequence numbers in any physical root sequence number set each correspond to a same cubic metric interval, a same maximum round-trip time interval, and a same maximum Doppler frequency shift interval. The specific rule may also be understood as a rule of mapping the physical root sequence number to a specific physical root sequence number set. The specific rule includes but is not limited to the following first rule to fourth rule.

### First Rule:

When a quantity K of maximum round-trip time intervals is equal to a quantity L of maximum Doppler frequency shift intervals, an arrangement order of the plurality of physical root sequence number sets satisfies the following: K×L physical root sequence number sets are sorted in ascending order of max {k, l}, where when max {k, l} are the same and are even numbers, k are sorted in ascending order, and for any k, l are sorted in descending order; or when max {k, l} are the same and are odd numbers, l are sorted in ascending order, and for any l, k are sorted in descending order.

The first rule is a rule in which a maximum round-trip time and a maximum Doppler frequency shift are synchronously/alternately increased and the maximum round-trip time is initially increased, to map each physical root sequence number to a corresponding physical root sequence number set.

According to the first rule, determining the physical root sequence number set based on each candidate physical root sequence number set includes: selecting i that maximizes max {kᵢ, lᵢ} from | [symbol] | candidate physical root sequence number sets as the physical root sequence number set; and when max {kᵢ, lᵢ} in a plurality of candidate physical root sequence number sets are the same and are even numbers, determining i that minimizes lᵢ as the physical root sequence number set, and if lᵢ in the plurality of candidate physical root sequence number sets are the same, determining i that maximizes kᵢ as the physical root sequence number set; or when max {kᵢ, lᵢ} in a plurality of candidate physical root sequence number sets are the same and are odd numbers, determining i that minimizes k; as the physical root sequence number set, and if kᵢ in the plurality of candidate physical root sequence number sets are the same, determining i that maximizes lᵢ as the physical root sequence number set.

### Second Rule:

When a quantity K of maximum round-trip time intervals is equal to a quantity L of maximum Doppler frequency shift intervals, an arrangement order of the plurality of physical root sequence number sets satisfies the following: K×L physical root sequence number sets are sorted in ascending order of max {k, l}, where when max {k, l} are the same and are even numbers, l are sorted in ascending order, and for any l, k are sorted in descending order; or when max {k, l} are the same and are odd numbers, k are sorted in ascending order, and for any k, l are sorted in descending order.

The second rule is a rule in which a maximum round-trip time and a maximum Doppler frequency shift are synchronously/alternately increased and the maximum Doppler frequency shift is initially increased, to map each physical root sequence number to a corresponding physical root sequence number set.

According to the second rule, determining the physical root sequence number set based on each candidate physical root sequence number set includes: selecting i that maximizes max {kᵢ, lᵢ} from | [symbol] | candidate physical root sequence number sets as the physical root sequence number set; and

when max {kᵢ, lᵢ} in a plurality of candidate physical root sequence number sets are the same and are even numbers, determining i that minimizes kᵢ as the physical root sequence number set, and if kᵢ in the plurality of candidate physical root sequence number sets are the same, determining i that maximizes lᵢ as the physical root sequence number set; or when max {kᵢ, lᵢ} in a plurality of candidate physical root sequence number sets are the same and are odd numbers, determining i that minimizes lᵢ as the physical root sequence number set, and if lᵢ in the plurality of candidate physical root sequence number sets are the same, determining i that maximizes kᵢ as the physical root sequence number set.

### Third Rule:

An arrangement order of the plurality of physical root sequence number sets satisfies the following: K×L physical root sequence number sets are sorted in ascending order of k, where when k are the same and are even numbers, l are sorted in ascending order; or when k are the same and are odd numbers, l are sorted in descending order.

The third rule is a rule in which a maximum round-trip time is monotonically increased, to map each physical root sequence number to a corresponding physical root sequence number set. This rule is compatible with a sorting rule in an existing protocol as much as possible, has a simple implementation, and reduces processing complexity.

According to the third rule, determining the physical root sequence number set based on each candidate physical root sequence number set includes: selecting i that maximizes k; from | [symbol] | candidate physical root sequence number sets as the physical root sequence number set; and when kᵢ in a plurality of candidate physical root sequence number sets are the same and are even numbers, determining i that maximizes lᵢ as the physical root sequence number set; or when kt in a plurality of candidate physical root sequence number sets are the same and are odd numbers, determining i that minimizes lᵢ as the physical root sequence number set.

### Fourth Rule:

An arrangement order of the plurality of physical root sequence number sets satisfies the following: K×L physical root sequence number sets are sorted in ascending order of l, where when l are the same and are even numbers, k are sorted in ascending order; or when l are the same and are odd numbers, k are sorted in descending order.

The fourth rule is a rule in which a maximum Doppler frequency shift is monotonically increased, to map each physical root sequence number to a corresponding physical root sequence number set. This rule has a simple implementation, and reduces processing complexity.

According to the fourth rule, determining the physical root sequence number set based on each candidate physical root sequence number set includes: selecting i that maximizes lᵢ from | [symbol] | candidate physical root sequence number sets as the physical root sequence number set; and when lᵢ in a plurality of candidate physical root sequence number sets are the same and are even numbers, determining i that maximizes kᵢ as the physical root sequence number set; or when lᵢ in a plurality of candidate physical root sequence number sets are the same and are odd numbers, determining i that minimizes kᵢ as the physical root sequence number set.

According to any one of the first rule to the fourth rule, all root sequence numbers in any physical root sequence number set each may correspond to a same cubic metric interval, a same maximum round-trip time interval, and a same maximum Doppler frequency shift interval. A rule to be used is not limited in embodiments of this application.

According to a fourth aspect, an embodiment of this application provides a communication apparatus. The communication apparatus has a function of implementing behavior in the method example according to the first aspect to the third aspect. For beneficial effect, refer to related descriptions of the first aspect to the third aspect. Details are not described herein again. For example, the communication apparatus may be the terminal device or the network device in the first aspect to the third aspect. For another example, the communication apparatus may be an apparatus that can support the terminal device in implementing functions required for the methods provided in the first aspect to the third aspect. For example, the communication apparatus may be a chip or a chip system in the terminal device, or the communication apparatus may be a chip or a chip system in the network device.

In a possible design, the communication apparatus includes a baseband apparatus and a radio frequency apparatus.

In a possible design, the communication apparatus includes a corresponding means (means) or module (for example, a chip, a chip system, or a circuit) for performing the method in any one of the first aspect to the third aspect. For example, the communication apparatus includes a processing unit (sometimes also referred to as a processing module or a processor) and/or a transceiver unit (sometimes also referred to as a transceiver module or a transceiver). The transceiver unit can implement a sending function and a receiving function. When the transceiver unit implements the sending function, the transceiver unit may be referred to as a sending unit (sometimes also referred to as a sending module), and when the transceiver unit implements the receiving function, the transceiver unit may be referred to as a receiving unit (sometimes also referred to as a receiving module). The sending unit and the receiving unit may be a same functional unit, the functional unit is referred to as the transceiver unit, and the functional unit can implement the sending function and the receiving function. Alternatively, the sending unit and the receiving unit may be different functional units, and the transceiver unit is a general term for these functional units. These units (modules) may execute corresponding functions in the method example in any one of the first aspect to the third aspect. For details, refer to detailed descriptions in the method example. Details are not described herein.

According to a fifth aspect, an embodiment of this application provides a communication apparatus. The communication apparatus may be the communication apparatus in the fourth aspect of the foregoing embodiments, or may be a chip or a chip system disposed in the communication apparatus in the fourth aspect. The communication apparatus includes a communication interface and a processor, and optionally, further includes a memory. The memory is configured to store a computer program, instructions, or data, and the processor is coupled to the memory and the communication interface. When the processor reads the computer program, the instructions, or the data, the communication apparatus is enabled to perform the methods performed by the terminal device in the foregoing method embodiments. For example, the communication apparatus may be a terminal device or a functional module in the terminal device, for example, a baseband chip and a radio frequency chip. Alternatively, when the processor reads the computer program, the instructions, or the data, the communication apparatus is enabled to perform the method performed by the network device in the foregoing method embodiments. For example, the communication apparatus may be a network device or a functional module in the network device, for example, a baseband chip and a radio frequency chip.

According to a sixth aspect, an embodiment of this application provides a chip system. The chip system includes a processor, may further include a communication interface, and is configured to implement the method according to any one of the first aspect to the third aspect. Optionally, the chip system further includes the memory. The memory is configured to store a computer program (which may also be referred to as code or instructions). The processor is configured to invoke the computer program from the memory and run the computer program, so that the device on which the chip system is installed performs the method in any one of the first aspect and the possible implementations of the first aspect, or the device on which the chip system is installed performs the method in any one of the second aspect and the possible implementations of the second aspect, or the device on which the chip system is installed performs the method in any one of the third aspect and the possible implementations of the third aspect. The chip system may include a chip, or may include a chip and another discrete component.

According to a seventh aspect, an embodiment of this application provides a communication apparatus. The communication apparatus includes an input/output interface and a logic circuit. The input/output interface is configured to input and/or output information. The input/output interface may be an interface circuit, an output circuit, an input circuit, a pin, a related circuit, or the like. The logic circuit is configured to perform the method according to any one of the first aspect to the third aspect.

During specific implementation, the communication apparatus may be a chip, the input circuit may be an input pin, the output circuit may be an output pin, and the logic circuit may be a transistor, a gate circuit, a trigger, any logic circuit, and the like. An input signal received by the input circuit may be received and input by, for example, but not limited to, a receiver, a signal output by the output circuit may be output to, for example, but not limited to, a transmitter and transmitted by the transmitter, and the input circuit and the output circuit may be a same circuit, where the circuit is used as the input circuit and the output circuit at different moments. Specific implementations of the input/output interface and the logic circuit are not limited in this application.

In an implementation, when the communication apparatus is a wireless communication device, the wireless communication device may be a terminal device, for example, a mobile phone. The interface circuit may be a radio frequency processing chip in the wireless communication device, and a processing circuit may be a baseband processing chip in the wireless communication device.

According to an eighth aspect, an embodiment of this application provides a communication system. The communication system includes a terminal device and a network device. The terminal device is configured to implement the function of the method in the first aspect, and the network device is configured to implement the function of the method in the second aspect. Alternatively, the terminal device is configured to implement the function of the method in the third aspect, and the network device is configured to implement the function of the method in the third aspect.

According to a ninth aspect, an embodiment of this application provides a computer-readable storage medium. The computer-readable storage medium is configured to store a computer program or instructions. When the computer program or the instructions are run, the method in any one of the first aspect and the possible implementations of the first aspect is implemented, or the method in any one of the second aspect and the possible implementations of the second aspect is implemented, or the method in any one of the third aspect and the possible implementations of the third aspect is implemented.

According to a tenth aspect, an embodiment of this application further provides a computer program product including instructions. When the computer program product runs on a computer, the method in any one of the first aspect and the possible implementations of the first aspect is implemented, or the method in any one of the second aspect and the possible implementations of the second aspect is implemented, or the method in any one of the third aspect and the possible implementations of the third aspect is implemented.

For beneficial effects of the fourth aspect to the tenth aspect and the implementations of the fourth aspect to the tenth aspect, refer to the descriptions of the beneficial effects of any one of the first aspect to the third aspect and the possible implementations of the first aspect to the third aspect.

### BRIEF DESCRIPTION OF DRAWINGS

FIG. 1 is a diagram of an architecture of a communication system according to an embodiment of this application;

FIG. 2 is a diagram of mapping a ZC root sequence to a delay-Doppler coordinate system according to an embodiment of this application;

FIG. 3 is a diagram of mapping, according to a first rule, a ZC root sequence to a delay-Doppler coordinate system according to an embodiment of this application;

FIG. 4 is a diagram of mapping, according to a second rule, a ZC root sequence to a delay-Doppler coordinate system according to an embodiment of this application;

FIG. 5 is a diagram of mapping, according to a third rule, a ZC root sequence to a delay-Doppler coordinate system according to an embodiment of this application;

FIG. 6 is a diagram of mapping, according to a fourth rule, a ZC root sequence to a delay-Doppler coordinate system according to an embodiment of this application;

FIG. 7 is a schematic flowchart of a communication method 700 according to an embodiment of this application;

FIG. 8 is a diagram of a structure of a communication apparatus according to an embodiment of this application; and

FIG. 9 is a diagram of another structure of a communication apparatus according to an embodiment of this application.

### DESCRIPTION OF EMBODIMENTS

In the communication method provided in embodiments of this application, physical root sequences in any physical root sequence set allocated to a cell support a same maximum moving speed/maximum Doppler frequency shift interval, so that sequence utilization can be improved. With reference to the accompanying drawings, the following further describes the solutions provided in embodiments of this application.

The technical solutions provided in embodiments of this application may be applied to various wireless communication systems. For example, the methods provided in embodiments of this application may be applied to a communication system related to the 3rd generation partnership project (the 3rd generation partnership project, 3GPP), for example, an LTE communication system or a fifth generation (the fifth generation, 5G) mobile communication system, or may be applied to another next-generation mobile communication system, for example, a sixth generation (6G) communication system, or another similar communication system. The another similar communication system may include a wireless fidelity (wireless fidelity, Wi-Fi) system, a vehicle-to-everything (vehicle-to-everything, V2X) system, an internet of things (internet of things, IoT) system, a narrowband internet of things (narrowband internet of things, NB-IoT) system, and the like.

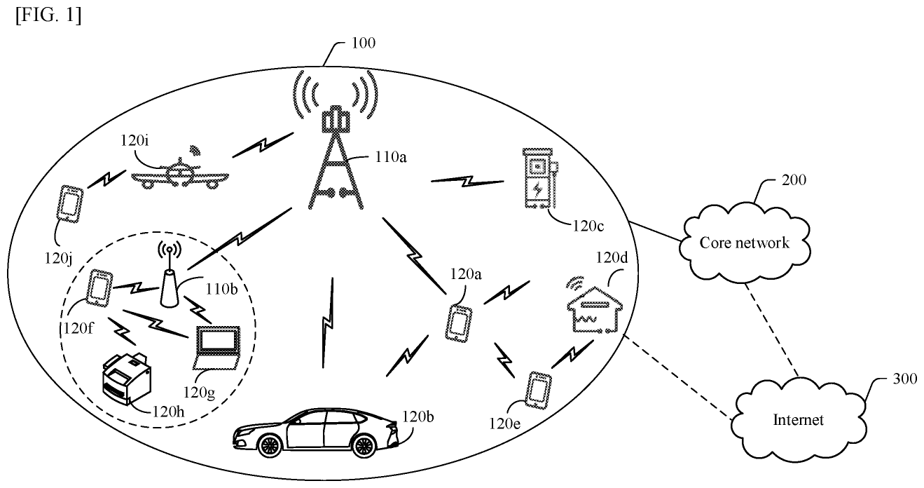

FIG. 1 shows a communication system to which an embodiment of this application is applicable. The communication system includes a radio access network 100 and a core network 200. Optionally, the communication system may further include an internet 300.

The radio access network 100 may include at least one network device and at least one terminal device. For example, the radio access network 100 includes two network devices 110a and 110b and terminal devices such as 120a to 120j. A network architecture shown in FIG. 1 is merely an example, and there may be fewer or more terminal devices and/or network devices. The communication system described in embodiments of this application is intended to describe the technical solutions in embodiments of this application more clearly, but constitutes no limitation on the communication system to which embodiments of this application are applicable. For example, the communication system may further include another device, and the another device includes, for example, a wireless relay device and a wireless backhaul device, which are not shown in FIG. 1. A person of ordinary skill in the art may know that with evolution of the network architecture, the technical solutions provided in embodiments of this application are also applicable to a similar technical problem. When the technical solutions in embodiments of this application are applied to another communication system, the devices, components, modules, and the like in embodiments may be replaced with corresponding devices, components, and modules in the another communication system. This is not limited.

The network device in embodiments of this application is mainly an access network device. Therefore, in the following descriptions, unless otherwise specified, the “network device” is a radio access network (radio access network, RAN) device, and may be briefly referred to as an access network device. A RAN may be a cellular system related to the 3GPP, for example, the 5G mobile communication system, or a future-oriented evolved system (for example, the 6G mobile communication system). Alternatively, a RAN may be an open access network (open RAN, O-RAN, or ORAN), a cloud radio access network (cloud radio access network, CRAN), a virtualized radio access network (virtualized RAN, vRAN), or the like. Alternatively, the RAN may be a communication system that integrates two or more of the foregoing systems. The RAN device may also be referred to as a RAN node, a RAN entity, an access node, or the like.

In a possible scenario, the RAN node may be a base station (base station), an evolved NodeB (evolved NodeB, eNodeB), an access point (access point, AP), a transmission reception point (transmission reception point, TRP), a next generation NodeB (next generation NodeB, gNB), a next-generation base station in the 6G mobile communication system, a base station in a future mobile communication system, or the like. The RAN node may be a macro base station, a micro base station, an indoor base station, a relay node, a donor node/host node, a radio controller, or the like. The RAN node may alternatively be a server, a wearable device, a vehicle, a vehicle-mounted device, or the like. For example, a RAN node in a V2X technology may be a road side unit (road side unit, RSU).

In another possible scenario, the RAN node may be a module or unit that completes a part of functions of a base station; or a plurality of RAN nodes cooperate to assist the terminal device in implementing radio access, and different RAN nodes separately implement a part of functions of a base station. For example, the RAN node may be a central unit (central unit, CU), a distributed unit (distributed unit, DU), or a radio unit (radio unit, RU). A function of the CU may be implemented by one entity, or may be implemented by different entities. For example, the functions of the CU may be further divided. That is, a control plane and a user plane are separated, and are implemented by different entities, which are a control plane CU entity (namely, a CU-control plane (control plane, CP) entity) and a user plane CU entity (namely, a CU-user plane (user plane, UP) entity). The CU-CP entity and the CU-UP entity may be coupled to the DU, to jointly complete functions of the RAN node. The CU and the DU may be separately disposed, or may be included in a same network element, for example, a baseband unit (baseband unit, BBU).

In different systems, the CU (or the CU-CP and the CU-UP), the DU, or the RU may alternatively have different names, but a person skilled in the art may understand meanings of the names. For example, in an ORAN system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as examples for description in this application. Any one of the CU (or the CU-CP and the CU-UP), the DU, and the RU in this application may be implemented by using a software module, a hardware module, or a combination of a software module and a hardware module.

The CU and the DU may be configured based on wireless network protocol layer functions implemented by the CU and the DU. For example, the CU is configured to implement functions of a packet data convergence protocol (packet data convergence protocol, PDCP) layer and a protocol layer (for example, a radio resource control (radio resource control, RRC) layer and/or a service data adaptation protocol (service data adaptation protocol, SDAP) layer) above the PDCP layer; and the DU is configured to implement functions of a protocol layer (for example, a radio link control (radio link control, RLC) layer, a MAC layer, and/or a physical (physical, PHY) layer) below the PDCP layer. For another example, the CU is configured to implement functions of a protocol layer above a PDCP layer (for example, an RRC layer and/or an SDAP layer), and the DU is configured to implement functions of the PDCP layer and a protocol layer below the PDCP layer (for example, an RLC layer, a MAC layer, and/or a PHY layer). For specific descriptions of the foregoing protocol layers, refer to a related technical specification of the 3GPP or a technical specification of another applicable communication protocol. Division into processing functions of the CU and the DU based on the protocol layers is merely an example. Division may alternatively be performed in another manner. This is not limited in this application. For example, in a design, the CU or the DU may alternatively have a part of processing functions of a protocol layer through division. In a design, a part of functions of the RLC layer and functions of a protocol layer above the RLC layer are set on the CU, and remaining functions of the RLC layer and functions of a protocol layer below the RLC layer are set on the DU.

In embodiments of this application, an apparatus configured to implement a function of the network device may be the network device, or may be an apparatus that can support the network device in implementing the function, for example, a chip system or a combined device or component that can implement the function of the network device. The apparatus may be installed in the network device. A specific technology and a specific device form that are used by the network device are not limited in embodiments of this application.

In embodiments of this application, any device that can perform data communication with the base station may be considered as the terminal device. The terminal device is also referred to as a terminal, user equipment (user equipment, UE), a mobile station, a mobile terminal, or the like. The terminal device may be widely used in various scenarios, for example, D2D communication, V2X communication, machine-type communication (machine-type communication, MTC), an IoT, virtual reality, augmented reality, industrial control, autonomous driving, telemedicine, a smart grid, smart furniture, smart office, smart wearables, smart transportation, or a smart city. For example, the terminal device may be a mobile phone, a computer, a mobile internet device (mobile internet device, MID), a wearable device, a virtual reality (virtual reality, VR) device, an augmented reality (augmented reality, AR) device, a robotic arm, a camera, a robot, a smart home device (for example, a television, an air conditioner, a robotic vacuum cleaner, a speaker, or a set-top box), a relay (relay), or customer premises equipment (customer premises equipment, CPE).

If the various terminal devices described above are located on a vehicle (for example, placed/mounted in the vehicle), the terminal devices may all be considered as vehicle-mounted terminal devices. The vehicle-mounted terminal device may be a vehicle-mounted module, a vehicle-mounted assembly, a vehicle-mounted component, a vehicle-mounted chip, or an on board unit that is built in a vehicle as one or more components or units. The vehicle may implement the method in this application through the built-in vehicle-mounted module, vehicle-mounted assembly, vehicle-mounted component, vehicle-mounted chip, or on board unit. The vehicle-mounted terminal device may be a vehicle device, an in-vehicle module, a vehicle, an on board unit (on board unit, OBU), a road side unit (road side unit, RSU), an in-vehicle infotainment system (or referred to as an in-vehicle sending unit) (telematics box, T-box), a chip, a system on chip (system on chip, SoC), or the like. The chip or the SoC may be mounted in the vehicle, the OBU, the RSU, or the T-box.

In embodiments of this application, an apparatus configured to implement a function of the terminal device may be the terminal device, or may be an apparatus that can support the terminal device in implementing the function, for example, a chip system or a combined device or component that can implement the function of the terminal device. The apparatus may be mounted in the terminal device. A specific technology and a specific device form used by the terminal device are not limited in embodiments of this application.

The terminal device may also be referred to as a terminal, a terminal apparatus, user equipment (user equipment, UE), a mobile station, a mobile terminal, or the like. The terminal may be widely used in various scenarios, for example, a device-to-device (device-to-device, D2D) scenario, a vehicle-to-everything (vehicle-to-everything, V2X) communication scenario, a machine-type communication (machine-type communication, MTC) scenario, an internet of things (internet of things, IOT) scenario, a virtual reality scenario, an augmented reality scenario, an industrial control scenario, an autonomous driving scenario, a telemedicine scenario, a smart grid scenario, a smart furniture scenario, a smart office scenario, a smart wearable scenario, a smart transportation scenario, and a smart city scenario. The terminal may be a mobile phone, a tablet computer, a computer with a wireless transceiver function, a wearable device, a vehicle, an uncrewed aerial vehicle, a helicopter, an airplane, a ship, a robot, a robotic arm, a smart home device, or the like. A specific technology and a specific device form that are used by the terminal are not limited in embodiments of this application.

In embodiments of this application, roles of the network device and the terminal may be relative. For example, a helicopter or an uncrewed aerial vehicle 120i in FIG. 1 may be configured as a mobile network device. For the terminal device 120j that accesses the radio access network 100 through 120i, the terminal device 120i is a network device. However, for the network device 110a, 120i is a terminal device, and 110a and 120i communicate with each other by using a radio air interface protocol. Certainly, 110a and 120i may alternatively communicate with each other by using an interface protocol between network devices. In this case, 120i is also a network device relative to 110a. Therefore, in embodiments of this application, the network device and the terminal device may be collectively referred to as communication apparatuses. 110a and 110b in FIG. 1 may be referred to as communication apparatuses having a function of a network device, and 120a to 120j in FIG. 1 may be referred to as communication apparatuses having a function of a terminal.

A sequence of a reference signal (for example, a demodulation reference signal (demodulation reference signal, DMRS) and a sounding reference signal (sounding reference signal, SRS) or a random access preamble) sent by the terminal device to the network device may be generated based on a root sequence. The root sequence may be a (Zadoff-Chu, ZC) root sequence or another possible sequence. For ease of understanding, some related content of the root sequence is first described. In the following description, an example in which the root sequence is a ZC sequence is used.

A zero correlation zone may be formed by using different cyclic shifts (cyclic shifts, CSs) of the root sequence. The zero correlation zone means that when there is no Doppler frequency shift, a value of a correlation function is equal to zero within a maximum round-trip time interval. In the zero correlation zone, a cyclic shift autocorrelation value of the ZC root sequence is equal to 0.

For example, for a ZC root sequence, a cyclic shift sequence with a value of a correlation function being equal to zero may be obtained by performing a cyclic shift on the ZC root sequence, and a value of a correlation function of any two sequences in the cyclic shift sequence is equal to zero. A cyclic shift sequence Suk (n) obtained by performing the cyclic shift on the ZC root sequence satisfies the following formula (1):

$${s}_{u , k} ( n ) = {e}^{- j π u ( n + k {Δ}_{T} ) ( n + k {Δ}_{T} + 1 ) / N} , n = 0 , 1 , … , N - 1 \qquad ( 1 )$$

In formula (1), N is a sequence length, u is a root sequence index, u=1, 2, . . . , N−1, Δ_{T} is a zero correlation zone or a maximum round-trip time, k is a cyclic shift index, k=0,1, . . . , [N/Δ_{T}]−1, and the operator └·┘ indicates rounding down. [N/Δ_{T}] ZC sequences s_{u,0}(n), s_{u,1}(n), . . . , S_{u,└N/Δ}_{_{T}}_{┘-1}(n) are shift-multiplexed in delay domain to form the zero correlation zone.

When there is a Doppler shift, an ambiguity function of s_{u,k}(n) has a plurality of peaks. An ambiguity function A(τ, v) satisfies formula (2):

$$A ( τ , ν ) = {\sum }_{n = 0}^{N - 1} {s}_{u , k} ( n ) {s}_{u , k}^{*} [ ( n - τ ) mod N ] {e}^{j 2 π n ν / N} \qquad ( 2 )$$

In formula (2), τ indicates a propagation delay, and v indicates a Doppler frequency shift. For meanings of other parameters, refer to formula (1).

To improve a capability of a ZC sequence in resisting the Doppler shift, in LTE and NR protocols, a cyclic shift of the ZC root sequence is further restricted, to restrict different cyclic shifts of the root sequence to a zero ambiguity zone. The zero ambiguity zone means that a value of an ambiguity function is equal to zero within a maximum round-trip time interval and a maximum Doppler frequency shift interval. It may be understood that the maximum round-trip time is related to a position of the terminal device, and a maximum Doppler frequency shift is related to a moving speed of the terminal device. Within a specific cell radius, if the moving speed of the terminal satisfies a restriction of the maximum Doppler frequency shift, mutual interference between any two sequences in the cyclic shift sequence is minimum, or mutual interference between any two sequences is equal to zero.

For a ZC root sequence, a cyclic shift sequence with a value of an ambiguity function being equal to zero may be obtained by further restricting a cyclic shift of the ZC root sequence. A value of an ambiguity function of any two sequences in the cyclic shift sequence is equal to zero. A ZC sequence s_{u,k}(n) of a cyclic shift of a restricted set satisfies the following formula (3):

$${s}_{u , k} ( n ) = {e}^{- j π u ( n + {C}_{k} ) ( n + {C}_{k} + 1 ) / N} , n = 0 , 1 , … , N - 1 \qquad ( 3 )$$

In formula (3), Cₖ indicates a cyclic shift of the root sequence. For meanings of other parameters, refer to formula (1).

In Release 8 (Release 8/Rel-8), it is proposed that a cyclic shift restricted sets type A (Restricted Sets Type A) resists a frequency offset of ±1 subcarrier spacing, and a quantity of available cyclic shifts does not exceed ⅓ of an unrestricted set. In Release 14 (Release 14/Rel-14), it is proposed that a cyclic shift restricted sets type B (Restricted Sets Type B) resists a frequency offset of ±2 subcarrier spacings, and a quantity of available cyclic shifts does not exceed ⅕ of an unrestricted set.

A random access preamble (preamble) set of a cell is obtained by performing a cyclic shift on the ZC root sequence, or the random access preamble set is formed by performing a cyclic shift on one or more root sequences. A random access preamble may also be referred to as a random access preamble code, an access preamble, a random access sequence, an access sequence, or the like. The terminal device may randomly select one random access preamble from at least one random access preamble included in the random access preamble set configured for the cell, and then send the random access preamble to the network device on a physical random access channel.

A specific random access preamble set may be configured for a cell, and is used by a terminal device in a coverage area of the cell to access a network device in the cell. A random access preamble set of each cell may be formed by cyclic shifts of a plurality of (for example, 64) ZC sequences, and each ZC sequence corresponds to one random access preamble identifier (identifier, ID). For example, the network device broadcasts a start root sequence number, and determines 64 ZC sequences in an order of “first traversing cyclic shifts and then traversing root sequence numbers”.

A sorting rule of root sequence numbers is as follows:
(1) Root sequences are divided into a low cubic metric group and a high cubic metric group by using a cubic metric CM (for example, referred to as a first cubic metric) as a boundary, where cubic metrics of physical root sequences indicated by all physical root sequence numbers in the low cubic metric group do not exceed the first cubic metric, and cubic metrics of physical root sequences indicated by all physical root sequence numbers in the high cubic metric group exceed the first cubic metric. The cubic metric CM reflects a degree of fluctuation of signal power with time. Optionally, CM satisfies the following:

$$CM = \frac{20 lg \{ rms [ {s}_{u , k}^{3} ( t ) ] \} - 1.52}{1.56} dB ,$$

where rms(·) indicates a root mean square, and t indicates a time variable.

For example, a sequence length of a root sequence satisfies the following: N=839, the first cubic metric CM=1.2 dB, and all root sequence numbers are divided into a low cubic metric group and a high cubic metric group by using CM=1.2 dB as a boundary. The low cubic metric group may include 456 root sequences, and the high cubic metric group may include 382 root sequences. CM=1.2 dB corresponds to a cubic metric of a quadrature phase shift keying (quadrature phase shift keying, QPSK) signal.
(2) For the low cubic metric group or the high cubic metric group, root sequences in the group are divided into 16 groups by using a maximum cell radius

$${Δ}_{T}^{max}$$

supported for resisting ±1 subcarrier frequency offset as a boundary, including

$$0 \leq {Δ}_{T}^{max} < 15 , 15 \leq {Δ}_{T}^{max} < 18 , 18 \leq {Δ}_{T}^{max} < 22 , 22 \leq {Δ}_{T}^{max} < 26 ,$$

$$26 \leq {Δ}_{T}^{max} < 32 , 32 \leq {Δ}_{T}^{max} < 38 , 38 \leq {Δ}_{T}^{max} < 46 , 46 \leq {Δ}_{T}^{max} < 55 ,$$

$$55 \leq {Δ}_{T}^{max} < 68 , 68 \leq {Δ}_{T}^{max} < 82 , 82 \leq {Δ}_{T}^{max} < 100 , 100 \leq {Δ}_{T}^{max} < 1 \; 28 ,$$

$$128 \leq {Δ}_{T}^{max} < 158 , 158 \leq {Δ}_{T}^{max} < 202 , 202 \leq {Δ}_{T}^{max} < 237 , and {Δ}_{T}^{max} \geq 237 .$$

(3) Arrangement is performed in a group in a cubic metric order. For the low cubic metric group, arrangement is performed in odd-numbered groups in descending order of cubic metrics, and arrangement is performed in even-numbered groups in ascending order of cubic metrics. For the high cubic metric group, arrangement is performed in odd-numbered groups in ascending order of cubic metrics, and arrangement is performed in even-numbered groups in descending order of cubic metrics. It may also be understood as that: for the low cubic metric group, alternate arrangement is performed, starting from a last physical root sequence number set, in ascending and descending order of cubic metrics, and arrangement is performed in the last physical root sequence number set in ascending order of cubic metrics; and for the high cubic metric group, alternate arrangement is performed, starting from a first physical root sequence number set, in ascending and descending order of cubic metrics, and arrangement is performed in the first physical root sequence number set in ascending order of cubic metrics. The first physical root sequence number set in the high cubic metric group is the last physical root sequence number set in the low cubic metric group.

Root sequences that are sequentially sorted are obtained according to the foregoing sorting rule. A relationship between a logical root sequence number and a physical root sequence number shown in Table 1 may be obtained by setting a logical root sequence number for the sorted root sequence or sequentially and continuously numbering the sorted root sequences starting from 0. It may be understood that the physical root sequence number in Table 1 is an actual number of the root sequence. The logical root sequence number may represent a position of a physical root sequence number corresponding to the logical root sequence number in all physical root sequence numbers. In other words, the logical root sequence number is a position index of the corresponding physical root sequence number in all the physical root sequence numbers. The network device or the terminal device may determine, based on the logical root sequence number and Table 1, the physical root sequence number corresponding to the logical root sequence number, further determine a physical root sequence, and then perform a cyclic shift on the physical root sequence to obtain a random access preamble.

TABLE 1

| Logical root | Physical root sequence number u (corresponding to the logical root |
|---|---|
| sequence number | sequence number in ascending order) |
| 0-23 | 129, 710, 140, 699, 120, 719, 210, 629, 168, 671, 84, 755, 105, 734, |
| | 93, 746, 70, 769, 60, 779 |
| | 2, 837, 1, 838 |
| 24-29 | 56, 783, 112, 727, 148, 691 |
| 30-35 | 80, 759, 42, 797, 40, 799 |
| 36-41 | 35, 804, 73, 766, 146, 693 |
| 42-51 | 31, 808, 28, 811, 30, 809, 27, 812, 29, 810 |
| 52-63 | 24, 815, 48, 791, 68, 771, 74, 765, 178, 661, 136, 703 |
| 64-75 | 86, 753, 78, 761, 43, 796, 39, 800, 20, 819, 21, 818 |
| 76-89 | 95, 744, 202, 637, 190, 649, 181, 658, 137, 702, 125, 714, 151, 688 |
| 90-115 | 217, 622, 128, 711, 142, 697, 122, 717, 203, 636, 118, 721, 110, 729, |
| | 89, 750, 103, 736, 61, 778, 55, 784, 15, 824, 14, 825 |
| 116-135 | 12, 827, 23, 816, 34, 805, 37, 802, 46, 793, 207, 632, 179, 660, 145, |
| | 694, 130, 709, 223, 616 |
| 136-167 | 228, 611, 227, 612, 132, 707, 133, 706, 143, 696, 135, 704, 161, 678, |
| | 201, 638, 173, 666, 106, 733, 83, 756, 91, 748, 66, 773, 53, 786, 10, 829, |
| | 9,830 |
| 168-203 | 7, 832, 8, 831, 16, 823, 47, 792, 64, 775, 57, 782, 104, 735, 101, 738, |
| | 108, 731, 208, 631, 184, 655, 197, 642, 191, 648, 121, 718, 141, 698, 149, |
| | 690, 216, 623, 218, 621 |
| 204-263 | 152, 687, 144, 695, 134, 705, 138, 701, 199, 640, 162, 677, 176, 663, |
| | 119, 720, 158, 681, 164, 675, 174, 665, 171, 668, 170, 669, 87, 752, 169, |
| | 670, 88, 751, 107, 732, 81, 758, 82, 757, 100, 739, 98, 741, 71, 768, 59, |
| | 780, 65, 774, 50, 789, 49, 790, 26, 813, 17, 822, 13, 826, 6, 833 |
| 264-327 | 5, 834, 33, 806, 51, 788, 75, 764, 99, 740, 96, 743, 97, 742, 166, 673, |
| | 172, 667, 175, 664, 187, 652, 163, 676, 185, 654, 200, 639, 114, 725, 189, |
| | 650, 115, 724, 194, 645, 195, 644, 192, 647, 182, 657, 157, 682, 156, 683, |
| | 211, 628, 154, 685, 123, 716, 139, 700, 212, 627, 153, 686, 213, 626, 215, |
| | 624, 150, 689 |
| 328-383 | 225, 614, 224, 615, 221, 618, 220, 619, 127, 712, 147, 692, 124, 715, |
| | 193, 646, 205, 634, 206, 633, 116, 723, 160, 679, 186, 653, 167, 672, 79, |
| | 760, 85, 754, 77, 762, 92, 747, 58, 781, 62, 777, 69, 770, 54, 785, 36, 803, |
| | 32, 807, 25, 814, 18, 821, 11, 828, 4, 835 |
| 384-455 | 3, 836, 19, 820, 22, 817, 41, 798, 38, 801, 44, 795, 52, 787, 45, 794, |
| | 63, 776, 67, 772, 72 |
| | 767, 76, 763, 94, 745, 102, 737, 90, 749, 109, 730, 165, 674, 111, |
| | 728, 209, 630, 204, 635, 117, 722, 188, 651, 159, 680, 198, 641, 113, 726, |
| | 183, 656, 180, 659, 177, 662, 196, 643, 155, 684, 214, 625, 126, 713, 131, |
| | 708, 219, 620, 222, 617, 226, 613 |
| 456-513 | 230, 609, 232, 607, 262, 577, 252, 587, 418, 421, 416, 423, 413, 426, |
| | 411, 428, 376, 463, 395, 444, 283, 556, 285, 554, 379, 460, 390, 449, 363, |
| | 476, 384, 455, 388, 451, 386, 453, 361, 478, 387, 452, 360, 479, 310, 529, |
| | 354, 485, 328, 511, 315, 524, 337, 502, 349, 490, 335, 504, 324, 515 |
| 514-561 | 323, 516, 320, 519, 334, 505, 359, 480, 295, 544, 385, 454, 292, 547, |
| | 291, 548, 381, 458, 399, 440, 380, 459, 397, 442, 369, 470, 377, 462, 410, |
| | 429, 407, 432, 281, 558, 414, 425, 247, 592, 277, 562, 271, 568, 272, 567, |
| | 264, 575, 259, 580 |
| 562-629 | 237, 602, 239, 600, 244, 595, 243, 596, 275, 564, 278, 561, 250, 589, |
| | 246, 593, 417, 422, 248, 591, 394, 445, 393, 446, 370, 469, 365, 474, 300, |
| | 539, 299, 540, 364, 475, 362, 477, 298, 541, 312, 527, 313, 526, 314, 525, |
| | 353, 486, 352, 487, 343, 496, 327, 512, 350, 489, 326, 513, 319, 520, 332, |
| | 507, 333, 506, 348, 491, 347, 492, 322, 517 |
| 630-659 | 330, 509, 338, 501, 341, 498, 340, 499, 342, 497, 301, 538, 366, 473, |
| | 401, 438, 371, 468, 408, 431, 375, 464, 249, 590, 269, 570, 238, 601, 234, |
| | 605 |
| 660-707 | 257, 582, 273, 566, 255, 584, 254, 585, 245, 594, 251, 588, 412, 427, |
| | 372, 467, 282, 557, 403, 436, 396, 443, 392, 447, 391, 448, 382, 457, 389, |
| | 450, 294, 545, 297, 542, 311, 528, 344, 495, 345, 494, 318, 521, 331, 508, |
| | 325, 514, 321, 518 |
| 708-729 | 346, 493, 339, 500, 351, 488, 306, 533, 289, 550, 400, 439, 378, 461, |
| | 374, 465, 415, 424, 270, 569, 241, 598 |
| 730-751 | 231, 608, 260, 579, 268, 571, 276, 563, 409, 430, 398, 441, 290, 549, |
| | 304, 535, 308, 531, 358, 481, 316, 523 |
| 752-765 | 293, 546, 288, 551, 284, 555, 368, 471, 253, 586, 256, 583, 263, 576 |
| 766-777 | 242, 597, 274, 565, 402, 437, 383, 456, 357, 482, 329, 510 |
| 778-789 | 317, 522, 307, 532, 286, 553, 287, 552, 266, 573, 261, 578 |
| 790-795 | 236, 603, 303, 536, 356, 483 |
| 796-803 | 355, 484, 405, 434, 404, 435, 406, 433 |
| 804-809 | 235, 604, 267, 572, 302, 537 |
| 810-815 | 309, 530, 265, 574, 233, 606 |
| 816-819 | 367, 472, 296, 543 |
| 820-837 | 336, 503, 305, 534, 373, 466, 280, 559, 279, 560, 419, 420, 240, 599, |
| | 258, 581, 229, 610 |

In Table 1, for a low cubic metric group or a high cubic metric group, root sequences in the group are divided into a plurality of physical root sequence number sets by using a maximum cell radius supported for resisting ±1 subcarrier frequency offset as a boundary, so that root sequence numbers in a same physical root sequence number set support a same maximum cell radius, a same cubic metric, and a same maximum moving speed. However, for the low cubic metric group or the high cubic metric group, it is supported in a protocol that root sequences in the group are divided by using a maximum cell radius supported for resisting a plurality of subcarrier frequency offsets as a boundary. As a result, root sequence numbers in a same physical root sequence number set support a same maximum cell radius and a same cubic metric, but support a plurality of different maximum moving speeds. In other words, root sequence numbers in a same physical root sequence number set correspond to a same maximum round-trip time interval and a same cubic metric, but correspond to a plurality of different maximum Doppler frequency shift intervals. In a high-speed movement scenario, a maximum moving speed inevitably jumps in adjacent sequences. As a result, there is an unavailable root sequence in a physical root sequence number set, and sequence utilization is low.

To resolve the foregoing technical problem, solutions in embodiments of this application are provided. In embodiments of this application, a plurality of consecutive physical root sequence numbers in all physical root sequences correspond to a same cubic metric interval, a same maximum round-trip time interval, and a same maximum Doppler frequency shift interval. The plurality of consecutive physical root sequence numbers in all the physical root sequences may be considered as a physical root sequence number set or a group of physical root sequence numbers. From this perspective, that a plurality of consecutive physical root sequence numbers in all physical root sequences correspond to a same cubic metric interval, a same maximum round-trip time interval, and a same maximum Doppler frequency shift interval may be replaced with: Root sequence numbers in any physical root sequence number set correspond to a same cubic metric interval, a same maximum round-trip time interval, and a same maximum Doppler frequency shift interval. In this way, even if the terminal device moves at a high speed, a maximum moving speed does not jump in adjacent sequences, so that all physical root sequences in one physical root sequence set are available to the terminal device, thereby improving sequence utilization. In embodiments of this application, that root sequence numbers in one physical root sequence number set each correspond to a same cubic metric interval, a same maximum round-trip time interval, and a same maximum Doppler frequency shift interval may be understood as: Root sequence numbers in one physical root sequence number set each support a same maximum cell radius, a same cubic metric, and a same maximum moving speed.

To make root sequence numbers in one physical root sequence number set each correspond to a same cubic metric interval, a same maximum round-trip time interval, and a same maximum Doppler frequency shift interval, this application provides a method for sorting physical root sequence numbers. All physical root sequence numbers are sorted according to the sorting method, and a logical root sequence number is set for each sorted physical root sequence number, so that a mapping relationship between the logical root sequence number and the physical root sequence number can be obtained. The logical root sequence number is a position index of the corresponding physical root sequence number in all the physical root sequence numbers. In the mapping relationship, root sequence numbers in any physical root sequence number set each correspond to a same cubic metric interval, a same maximum round-trip time interval, and a same maximum Doppler frequency shift interval. Unless otherwise specified, in embodiments of this application, concepts of “set” and “group” are the same, and the two may be replaced with each other.

The following first describes a method for sorting physical root sequence numbers according to an embodiment of this application. According to the sorting method, all physical root sequence numbers may be divided into a plurality of physical root sequence number sets. Specifically, the plurality of physical root sequence number sets are obtained according to the following division rule:
(1) All the physical root sequence numbers are divided into a low cubic metric group and a high cubic metric group by using a first cubic metric as a boundary, where cubic metrics of physical root sequences indicated by all physical root sequence numbers in the low cubic metric group do not exceed the first cubic metric, and cubic metrics of physical root sequences indicated by all physical root sequence numbers in the high cubic metric group exceed the first cubic metric. For example, the first cubic metric may be a cubic metric (namely, 1.2 dB) of a QPSK signal. Alternatively, the first cubic metric may be a cubic metric corresponding to another modulation and coding scheme. A modulation and coding scheme corresponding to the first cubic metric is not limited in embodiments of this application. In addition, in (1), an example in which all the physical root sequence numbers are divided into the low cubic metric group and the high cubic metric group (namely, two cubic metric groups) by using the first cubic metric as a boundary is used. A specific quantity of a plurality of cubic metric groups into which all the physical root sequence numbers are divided is not limited in embodiments of this application. For example, all the physical root sequence numbers may be divided into three cubic metric groups by using two cubic metrics as a boundary. The three cubic metric groups may be: a low cubic metric group, a medium cubic metric group, and a high cubic metric group.
(2) All the physical root sequence numbers in each cubic metric group are divided into a plurality of physical root sequence number sets by using a maximum round-trip time and a maximum Doppler frequency shift as a boundary. The low cubic metric group and the high cubic metric group are used as an example. For the low cubic metric group and the high cubic metric group, all physical root sequence numbers in each group are divided into a plurality of physical root sequence number sets by using a maximum round-trip time and a maximum Doppler frequency shift as a boundary.
(3) Physical root sequence numbers in each of the plurality of physical root sequence number sets are arranged in a cubic metric order. For example, physical root sequence number sets in the low cubic metric group are first sorted, and then physical root sequence number sets in the high cubic metric group are sorted. A first physical root sequence number set in the high cubic metric group is a last physical root sequence number set in the low cubic metric group.

For the low cubic metric group, alternate arrangement is performed, starting from the last physical root sequence number set, in ascending and descending order of cubic metrics, where arrangement is performed in the last physical root sequence number set in ascending order of cubic metrics; and for the high cubic metric group, alternate arrangement is performed, starting from the first physical root sequence number set, in ascending and descending order of cubic metrics, where arrangement is performed in the first physical root sequence number set in ascending order of cubic metrics. Alternatively, for the low cubic metric group, arrangement is performed in odd-numbered groups in descending order of cubic metrics, and arrangement is performed in even-numbered groups in ascending order of cubic metrics; and for the high cubic metric group, arrangement is performed in odd-numbered groups in ascending order of cubic metrics, and arrangement is performed in even-numbered groups in descending order of cubic metrics.

In addition, for the low cubic metric group and the high cubic metric group, all physical root sequence numbers in each group are divided into a plurality of physical root sequence number sets by using a maximum round-trip time and a maximum Doppler frequency shift as a boundary. In comparison with that in Table 1 in which all physical root sequence numbers in a group are divided into a plurality of physical root sequence number sets by using a supported maximum cell radius as a boundary, root sequence numbers in any physical root sequence number set may correspond to a same cubic metric interval, a same maximum round-trip time interval, and a same maximum Doppler frequency shift interval.

The following describes in detail how to sort all physical root sequence numbers.

As described above, when there is a Doppler shift, an ambiguity function of the physical root sequence has a plurality of peaks, in other words, the ambiguity function of the physical root sequence has a plurality of peak values. To reduce interference, a candidate peak value of the ambiguity function of the physical root sequence may be first determined. A peak value of the ambiguity function corresponds to a delay domain dimension and a Doppler domain dimension. Therefore, the peak value of the ambiguity function is mapped to a delay-Doppler coordinate system, and the peak value of the ambiguity function is a point in the delay-Doppler coordinate system. Correspondingly, the candidate peak value of the ambiguity function of the physical root sequence is also referred to as a candidate peak point of the ambiguity function in the delay-Doppler coordinate system. A horizontal axis in the delay-Doppler coordinate system indicates delay domain, and a vertical axis in the delay-Doppler coordinate system indicates Doppler domain.

In this embodiment of this application, in all peak points of an ambiguity function of any physical root sequence (for example, a first physical root sequence) in a specified area, if a delay spacing and a Doppler spacing between a peak point and a coordinate origin are not both greater than a delay spacing and a Doppler spacing between the coordinate origin and any peak point of the ambiguity function other than the coordinate origin on a two-dimensional plane, the peak point is a candidate peak point. In other words, in the delay-Doppler coordinate system, a delay spacing between the candidate peak point of the ambiguity function of the first physical root sequence and the coordinate origin in the delay-Doppler coordinate system is not greater than a delay spacing between the coordinate origin and any peak point other than the coordinate origin. Alternatively, a Doppler spacing between the candidate peak point of the ambiguity function of the first physical root sequence and the coordinate origin in the delay-Doppler coordinate system is not greater than a Doppler spacing between the any other peak point and the coordinate origin. Alternatively, the delay spacing between the candidate peak point of the ambiguity function of the first physical root sequence and the coordinate origin in the delay-Doppler coordinate system is not greater than the delay spacing between the coordinate origin and the any peak point other than the coordinate origin; and the Doppler spacing between the candidate peak point of the ambiguity function of the first physical root sequence and the coordinate origin in the delay-Doppler coordinate system is not greater than the Doppler spacing between the any other peak point and the coordinate origin. It may be understood that a final peak point corresponding to the root sequence is determined from candidate peak points. According to the manner of determining the candidate peak point in this embodiment of this application, the root sequence corresponding to the finally selected peak point may correspond to a larger maximum round-trip time interval and/or a larger maximum Doppler frequency shift interval as much as possible, in other words, a maximum cell radius and/or a maximum moving speed supported by the root sequence corresponding to the finally selected peak point are/is as large as possible.

For example, a set of coordinates of the candidate peak points of the ambiguity function is [symbol] , and [symbol] ={ [symbol] , [symbol] , . . . , [symbol] }, where τᵢ indicates a delay coordinate of an i^{th} candidate peak point in the set S of the coordinates of the candidate peak points of the ambiguity function, vᵢ indicates a Doppler coordinate of the i^{th} candidate peak point in the set [symbol] of the coordinates of the candidate peak points of the ambiguity function, 0≤i≤| [symbol] |−1, and the operator |·| indicates cardinality of the set. The first physical root sequence is used as an example. A set [symbol] of coordinates of candidate peak points of the ambiguity function of the first physical root sequence satisfies the following.

$$𝒮 = \{ 〈 τ , u τ mod N 〉 \vert min \{ \pm u τ mod N \} < {min}_{n = 1 , 2 , … , τ - 1} \{ \pm un mod N \} , τ ∈ \{ 1 , 2 , … , ( N - 1 ) / 2 \} \} .$$

N indicates a sequence length of the first physical root sequence, and u indicates a first physical root sequence number. In ±uτ mod N, a positive/negative operation is performed first, and then a modulo operation is performed. In ±un mod N, a positive/negative operation is performed first, and then a modulo operation is performed.

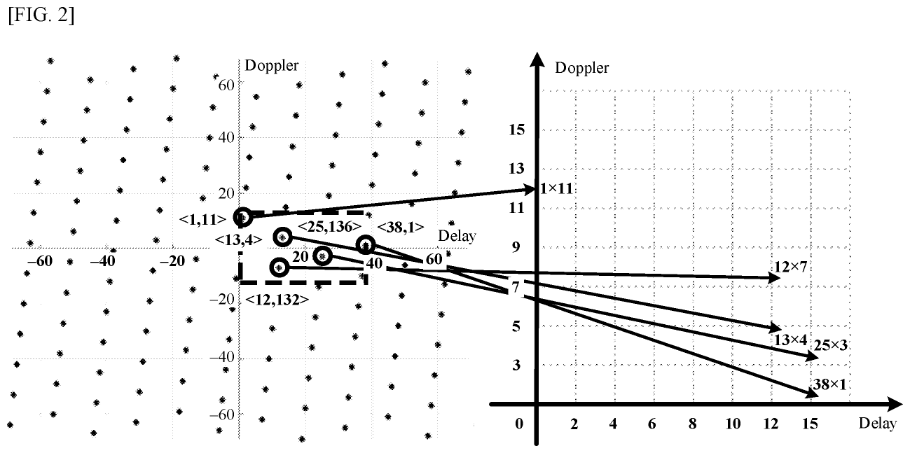

For ease of understanding, FIG. 2 is a diagram of mapping a ZC root sequence to a delay-Doppler domain coordinate system. In FIG. 2, a sequence length N=139 and a root sequence number u=11 are used as an example. In FIG. 2, a candidate peak point set [symbol] includes 5 candidate peak points, that is, [symbol] ≙{ [symbol] , [symbol] , [symbol] , [symbol] , [symbol] }={ [symbol] , [symbol] , [symbol] , [symbol] , [symbol] }. A delay spacing and a Doppler spacing between any candidate peak point and a coordinate origin are not both greater than a delay spacing and a Doppler spacing between the coordinate origin and any peak point of an ambiguity function other than the coordinate origin on a two-dimensional plane.

To improve a capability of a ZC sequence in resisting a Doppler shift, a value of the ambiguity function needs not to exceed a preset threshold or even a value of the ambiguity function needs to be equal to zero within a maximum round-trip time interval and a maximum Doppler frequency shift interval. Therefore, after a candidate peak point set of an ambiguity function of a first physical root sequence number is determined, a candidate maximum zero ambiguity zone corresponding to each candidate peak point set may be determined. A maximum cell radius supported by the candidate maximum zero ambiguity zone corresponds to a delay spacing between a candidate peak point and the coordinate origin, and a maximum moving speed supported by the candidate maximum zero ambiguity zone corresponds to a Doppler spacing between the candidate peak point and the coordinate origin. In other words, the maximum cell radius corresponds to a maximum round-trip time interval, and the maximum moving speed corresponds to a maximum Doppler frequency shift interval. From this perspective, determining the candidate maximum zero ambiguity zone corresponding to each candidate peak point set is determining a candidate maximum round-trip time interval and a candidate maximum Doppler frequency shift interval that correspond to each candidate peak point set.

In this embodiment of this application, any candidate peak point of an ambiguity function of a physical root sequence is located in a candidate maximum zero ambiguity zone. The candidate maximum zero ambiguity zone corresponds to a candidate maximum round-trip time interval and a candidate maximum Doppler frequency shift interval. Coordinates [symbol] of an i^{th} candidate peak point in a set [symbol] are used as an example. It is assumed that an i^{th} candidate physical root sequence number set is Δ_{T,k}_{ᵢ}×Δ_{F,l}_{ᵢ}. In this case, a maximum round-trip time interval [Δ_{T,k}_{ᵢ}, Δ_{T,k}_{ᵢ}₊₁) and a maximum Doppler frequency shift interval [Δ_{F,l}_{ᵢ}, Δ_{F,l}_{ᵢ}₊₁) that correspond to Δ_{T,k}_{ᵢ}×Δ_{F,l}_{ᵢ} satisfy the following:

$${τ}_{i} \times min \{ {v}_{i} , N - {v}_{i} \} ∈ [ {Δ}_{T , {k}_{i}} , {Δ}_{T , {k}_{i} + 1} ) \times [ {Δ}_{F , {l}_{i}} , {Δ}_{F , {l}_{i} + 1} )$$

[Δ_{T,0}, Δ_{T,1}), [Δ_{T,1}, Δ_{T,2}), . . . , [Δ_{T,K-1}, +∞) indicates K preset maximum round-trip time intervals in the physical root sequence number set, [Δ_{F,0}, Δ_{F,1}), [Δ_{F,1}, Δ_{F,2}), . . . , [Δ_{F,L-1}, +∞) indicates L preset maximum Doppler frequency shift intervals in the physical root sequence number set, 0≤kᵢ≤K−1, 0×lᵢ≤L−1, and 0≤i≤| [symbol] |−1. For any specified i, Δ_{T,i}×Δ_{F,i}=τᵢ×min{v₁, N−vᵢ}.

For ease of understanding, still refer to FIG. 2. The delay-Doppler domain coordinate system shown in FIG. 2 is divided into eight intervals in delay domain, where the eight intervals are [0,2), [2,4), [4,6), [6,8), [8,10), [10,12), [12,15), and [15, +∞); and is divided into eight intervals in Doppler domain, where the eight intervals are [0,3), [3,5), [5,7), [7,9), [9,11), [11,13), [13,15), and [15, +∞). For the candidate peak point set [symbol] ={(1,11), (12,132), (13,4), (25,136), (38,1)}, correspondingly, a candidate physical root sequence number set is Δ_{T,k}_{ᵢ}×Δ_{F,l}_{ᵢ}≙{Δ_{T,1}×Δ_{F,1}, Δ_{T,2}×Δ_{F,2}, Δ_{T,3}×Δ_{F,3}, Δ_{T,4}×Δ_{F,4}, Δ_{T,5}×Δ_{F,5}}={1×11,12×7,13×4,25×3,38×1}.

By analogy, a plurality of candidate physical root sequence number sets may be obtained. Candidate physical root sequence numbers in each candidate physical root sequence number set are sorted to determine a physical root sequence number set [Δ_{T,k}, Δ_{T,k+1})×[Δ_{F,l}, Δ_{F,l+1}) to which physical root sequence numbers belong, where k∈{0,1, . . . K−1}, l∈{0,1, . . . L−1}.

In this embodiment of this application, a maximum cell radius and a maximum moving speed that are supported in the candidate maximum zero ambiguity zone may be mapped to the delay-Doppler coordinate system, and the physical root sequence numbers in each candidate physical root sequence number set are sorted according to a specific rule. All the sorted physical root sequence numbers can ensure that a maximum cell radius and a maximum moving speed that are supported between adjacent physical root sequence number sets do not jump. For example,

$${Δ}_{T , {p}_{1}} \times {Δ}_{F , {p}_{1}} \times {Δ}_{T , {p}_{2}} \times {Δ}_{F , {p}_{2}} , … , {Δ}_{T , {p}_{\vert 𝒮 \vert}} \times {Δ}_{F , {p}_{\vert 𝒮 \vert}}$$

are obtained after the candidate physical root sequence number sets in the candidate maximum zero ambiguity zone are sorted, and a group that is farthest from the coordinate origin in delay domain and/or Doppler domain and that is mapped to a farthest end in the candidate maximum zero ambiguity zone may be selected as a position where a maximum zero ambiguity zone

$${Δ}_{T , {p}_{\vert 𝒮 \vert}} \times {Δ}_{F , {p}_{\vert 𝒮 \vert}}$$

is mapped to the group.

A sorting rule used for sorting all physical root sequence numbers is not limited in embodiments of this application, provided that the maximum cell radius and the maximum moving speed that are supported between adjacent physical root sequence number sets in all the sorted physical root sequence numbers do not jump. The following describes several possible sorting rules, and how to determine a physical root sequence number set based on a candidate physical root sequence number set according to each sorting rule. In the following description, an example in which there are K maximum round-trip time intervals and L maximum Doppler frequency shift intervals, and K=L is used. It may be understood that there are K×L physical root sequence number sets in total.

First rule: When a quantity K of maximum round-trip time intervals is equal to a quantity L of maximum Doppler frequency shift intervals, a maximum round-trip time and a maximum Doppler frequency shift are synchronously/alternately increased and the maximum round-trip time is initially increased, to map each physical root sequence number to a corresponding physical root sequence number set. An arrangement order of the plurality of physical root sequence number sets satisfies the following: K×L physical root sequence number sets are sorted in ascending order of max {k, l}, where when max {k, l} are the same and are even numbers, k are sorted in ascending order, and for any k, l are sorted in descending order; or when max {k, l} are the same and are odd numbers, l are sorted in ascending order, and for any l, k are sorted in descending order.

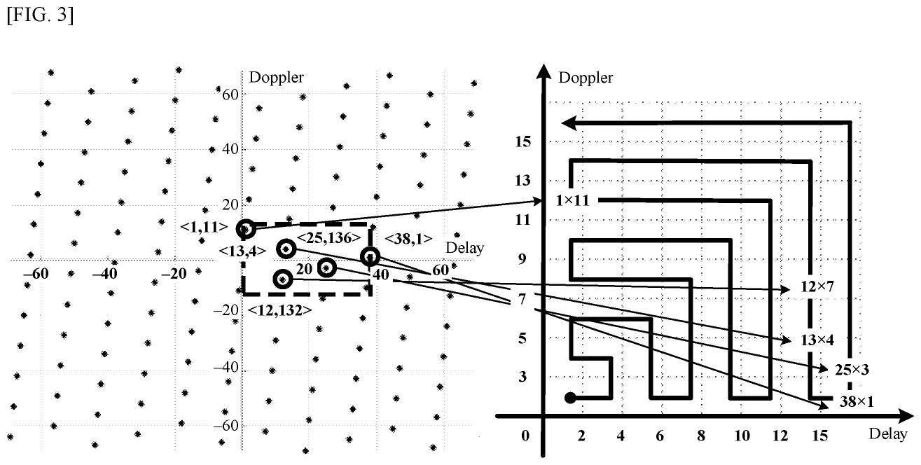

For ease of understanding, FIG. 3 is a diagram of mapping a ZC root sequence to a delay-Doppler domain coordinate system. In FIG. 3, a sequence length N=139 and a root sequence number u=11 are used as an example. In FIG. 3, the delay-Doppler domain coordinate system is divided into eight intervals in delay domain, where the eight intervals are [0,2), [2,4), [4,6), [6,8), [8,10), [10,12), [12,15), and [15, +∞); and is divided into eight intervals in Doppler domain, where the eight intervals are [0,3), [3,5), [5,7), [7,9), [9,11), [11,13), [13,15), and [15, +∞). A candidate peak point set [symbol] ={ [symbol] , [symbol] , [symbol] , [symbol] , [symbol] }, and a candidate physical root sequence number set Δ_{T,k}_{ᵢ}×Δ_{F,l}_{ᵢ}={Δ_{T,1}×Δ_{F,1}, Δ_{T,2}×Δ_{F,2}, Δ_{T,3}×Δ_{F,3}, Δ_{T,4}×Δ_{F,4}, Δ_{T,5}×Δ_{F,5}}={1×11,12×7,13×4,25×3,38×1}. Physical root sequence number sets are sorted according to the first rule, and after sorting, Δ_{T,k}_{ᵢ}×Δ_{F,l}_{ᵢ}={1×11,12×7,13×4,38×1,25×3}.

According to the first rule, determining the physical root sequence number set based on each candidate physical root sequence number set includes: selecting i that maximizes max {kᵢ, lᵢ} from | [symbol] | candidate physical root sequence number sets as the physical root sequence number set; and when max {kᵢ, lᵢ} in a plurality of candidate physical root sequence number sets are the same and are even numbers, determining i that minimizes lᵢ as the physical root sequence number set, and if lᵢ in the plurality of candidate physical root sequence number sets are the same, determining i that maximizes kᵢ as the physical root sequence number set; or when max {kᵢ, lᵢ} in a plurality of candidate physical root sequence number sets are the same and are odd numbers, determining i that minimizes kᵢ as the physical root sequence number set, and if kᵢ in the plurality of candidate physical root sequence number sets are the same, determining i that maximizes lᵢ as the physical root sequence number set. The example in FIG. 3 is still used. Δ_{T,5}×Δ_{F,5}=25×3 in a maximum zero ambiguity zone is finally mapped to an interval [15, +∞)×[3,5).

It may be understood that, all sorted physical root sequence numbers are obtained according to the first rule, and a mapping relationship between a logical root sequence number and a physical root sequence number may be obtained by setting logical root sequence numbers for all the sorted physical root sequence numbers or sequentially and continuously numbering all sorted physical root sequences starting from 0. The logical root sequence number is a position index of the corresponding physical root sequence number in all the physical root sequence numbers. The mapping relationship is similar to that in Table 1. For example, it is assumed that a sequence length N=13, maximum round-trip time intervals Δ_{T,1}=0, Δ_{T,2}=2, Δ_{T,3}=4, Δ_{T,4}=6, and maximum Doppler frequency shift intervals Δ_{F,1}=0, Δ_{F,2}=3, Δ_{F,3}=5, Δ_{F,4}=7. The mapping relationship that is between the logical root sequence number and the physical root sequence number and that is obtained according to the first rule may be shown in Table 2. It should be noted that Table 2 is merely an example.

TABLE 2

| Logical root sequence number | Physical root sequence number |
|---|---|
| 0-1 | 1, 12 |
| 2-3 | 3, 10 |
| 4-5 | 2, 11 |
| 6-7 | 4, 9 |
| 8-11 | 5, 8, 6, 7 |

Second rule: When a quantity K of maximum round-trip time intervals is equal to a quantity L of maximum Doppler frequency shift intervals, a maximum round-trip time and a maximum Doppler frequency shift are synchronously/alternately increased and the maximum Doppler frequency shift is initially increased, to map each physical root sequence number to a corresponding physical root sequence number set. In other words, an arrangement order of the plurality of physical root sequence number sets satisfies the following: K×L physical root sequence number sets are sorted in ascending order of max {k, l}, where when max {k, l} are the same and are even numbers, l are sorted in ascending order, and for any l, k are sorted in descending order; or when max {k, l} are the same and are odd numbers, k are sorted in ascending order, and for any k, l are sorted in descending order.

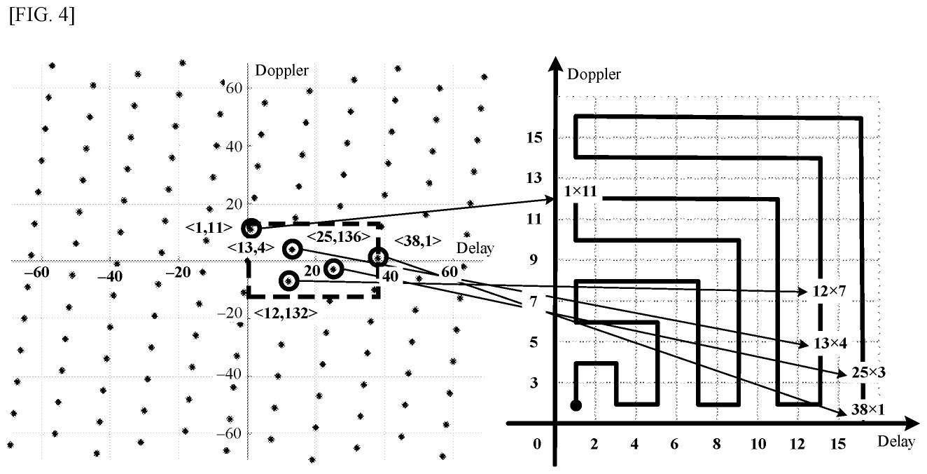

For ease of understanding, FIG. 4 is a diagram of mapping a ZC root sequence to a delay-Doppler domain coordinate system. In FIG. 4, a sequence length N=139 and a root sequence number u=11 are used as an example. In FIG. 4, the delay-Doppler domain coordinate system is divided into eight intervals in delay domain, where the eight intervals are [0,2), [2,4), [4,6), [6,8), [8,10), [10,12), [12,15), and [15, +∞); and is divided into eight intervals in Doppler domain, where the eight intervals are [0,3), [3,5), [5,7), [7,9), [9,11), [11,13), [13,15), and [15, +∞). A candidate peak point set [symbol] ={ [symbol] , [symbol] , [symbol] , [symbol] , [symbol] }, and a candidate physical root sequence number set Δ_{T,k}_{ᵢ}×Δ_{F,l}_{ᵢ}={Δ_{T,1}×Δ_{F,1}, Δ_{T,2}×Δ_{F,2}, Δ_{T,3}×Δ_{F,3}, Δ_{T,4}×Δ_{F,4}, Δ_{T,5}×Δ_{F,5}}={1×11,12×7,13×4,25×3,38×1}. Physical root sequence number sets are sorted according to the second rule, and after sorting, Δ_{T,k}_{ᵢ}×Δ_{F,l}_{ᵢ}={1×11,13×4,12×7,25×3,38×1}.

According to the second rule, determining the physical root sequence number set based on each candidate physical root sequence number set includes: selecting i that maximizes max {kᵢ, lᵢ} from | [symbol] | candidate physical root sequence number sets as the physical root sequence number set; and when max {kᵢ, lᵢ} in a plurality of candidate physical root sequence number sets are the same and are even numbers, determining i that minimizes kᵢ as the physical root sequence number set, and if kᵢ in the plurality of candidate physical root sequence number sets are the same, determining i that maximizes lᵢ as the physical root sequence number set; or when max {kᵢ, lᵢ} in a plurality of candidate physical root sequence number sets are the same and are odd numbers, determining i that minimizes lᵢ as the physical root sequence number set, and if lᵢ in the plurality of candidate physical root sequence number sets are the same, determining i that maximizes kᵢ as the physical root sequence number set. The example in FIG. 4 is still used. Δ_{T,5}×Δ_{F,5}=38×1 in a maximum zero ambiguity zone is finally mapped to an interval [15, +∞)×[0,3).

Similar to obtaining the mapping relationship between the logical root sequence number and the physical root sequence number according to the first rule, the mapping relationship between the logical root sequence number and the physical root sequence number may also be obtained according to the second rule. For example, it is assumed that a sequence length N=13, maximum round-trip time intervals Δ_{T,1}=0, Δ_{T,2}=2, Δ_{T,3}=4, Δ_{T,4}=6, and maximum Doppler frequency shift intervals Δ_{F,1}=0, Δ_{F,2}=3, Δ_{F,3}=5, Δ_{F,4}=7. The mapping relationship that is between the logical root sequence number and the physical root sequence number and that is obtained according to the second rule may be shown in Table 3. It should be noted that Table 3 is merely an example.

TABLE 3

| Logical root sequence number | Physical root sequence number |
|---|---|
| 0-1 | 1, 12 |
| 2-3 | 3, 10 |
| 4-5 | 2, 11 |
| 6-7 | 4, 9 |
| 8-11 | 5, 8, 6, 7 |

Third rule: A maximum round-trip time is monotonically increased, to map each physical root sequence number to a corresponding physical root sequence number set. This rule is compatible with a sorting rule in an existing protocol as much as possible, has a simple implementation, and reduces processing complexity. In other words, an arrangement order of the plurality of physical root sequence number sets satisfies the following: K x L physical root sequence number sets are sorted in ascending order of k, where when k are the same and are even numbers, l are sorted in ascending order; or when k are the same and are odd numbers, l are sorted in descending order.

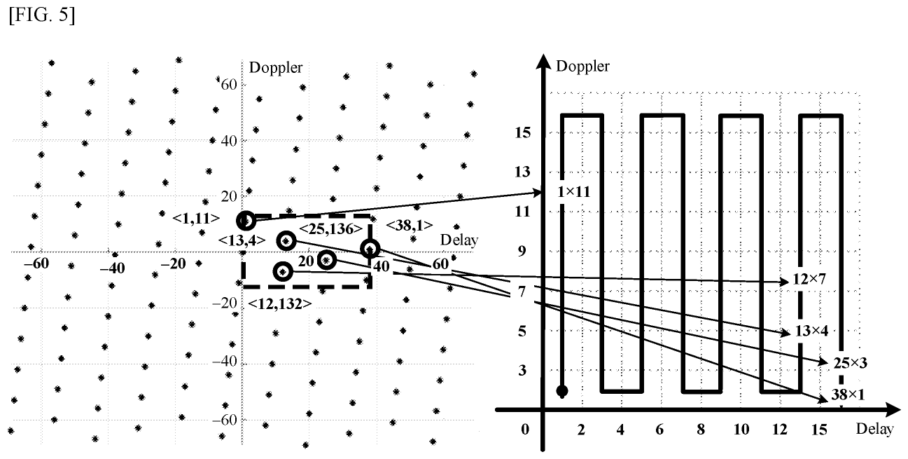

For ease of understanding, FIG. 5 is a diagram of mapping a ZC root sequence to a delay-Doppler domain coordinate system. In FIG. 5, a sequence length N=139 and a root sequence number u=11 are used as an example. In FIG. 5, the delay-Doppler domain coordinate system is divided into eight intervals in delay domain, where the eight intervals are [0,2), [2,4), [4,6), [6,8), [8,10), [10,12), [12,15), and [15, +∞); and is divided into eight intervals in Doppler domain, where the eight intervals are [0,3), [3,5), [5,7), [7,9), [9,11), [11,13), [13,15), and [15, +∞). A candidate peak point set [symbol] ={ [symbol] , [symbol] , [symbol] , [symbol] , [symbol] }, and a candidate physical root sequence number set Δ_{T,k}_{ᵢ}×Δ_{F,l}_{ᵢ}={Δ_{T,1}×Δ_{F,1}, Δ_{T,2}×Δ_{F,2}, Δ_{T,3}×Δ_{F,3}, Δ_{T,4}×Δ_{F,4}, Δ_{T,5}×Δ_{F,5}}={1×11,12×7,13×4,25×3,38×1}. Physical root sequence number sets are sorted according to the third rule, and after sorting, Δ_{T,k}_{ᵢ}×Δ_{F,l}_{ᵢ}={1×11,13×4,12×7,25×3,38×1}.

According to the third rule, determining the physical root sequence number set based on each candidate physical root sequence number set includes: selecting i that maximizes kᵢ from | [symbol] | candidate physical root sequence number sets as the physical root sequence number set; and when kᵢ in a plurality of candidate physical root sequence number sets are the same and are even numbers, determining i that maximizes lᵢ as the physical root sequence number set; or when kᵢ in a plurality of candidate physical root sequence number sets are the same and are odd numbers, determining i that minimizes lᵢ as the physical root sequence number set. The example in FIG. 5 is still used. Δ_{T,5}×Δ_{F,5}=38×1 in a maximum zero ambiguity zone is finally mapped to an interval [15, +∞)×[0,3).

Similar to obtaining the mapping relationship between the logical root sequence number and the physical root sequence number according to the first rule, the mapping relationship between the logical root sequence number and the physical root sequence number may also be obtained according to the third rule. For example, it is assumed that a sequence length N=13, maximum round-trip time intervals Δ_{T,1}=0, Δ_{T,2}=2, Δ_{T,3}=4, Δ_{T,4}=6, and maximum Doppler frequency shift intervals Δ_{F,1}=0, Δ_{F,2}=3, Δ_{F,3}=5, Δ_{F,4}=7. The mapping relationship that is between the logical root sequence number and the physical root sequence number and that is obtained according to the third rule may be shown in Table 4. It should be noted that Table 4 is merely an example.

TABLE 4

| Logical root sequence number | Physical root sequence number |
|---|---|
| 0-1 | 1, 12 |
| 2-3 | 3, 10 |
| 4-5 | 2, 11 |
| 6-7 | 5, 8 |
| 8-11 | 6, 7, 4, 9 |

Fourth rule: A maximum Doppler frequency shift is monotonically increased, to map each physical root sequence number to a corresponding physical root sequence number set. This rule has a simple implementation, and reduces processing complexity. In other words, an arrangement order of the plurality of physical root sequence number sets satisfies the following: K×L physical root sequence number sets are sorted in ascending order of l, where when I are the same and are even numbers, k are sorted in ascending order; or when l are the same and are odd numbers, k are sorted in descending order.

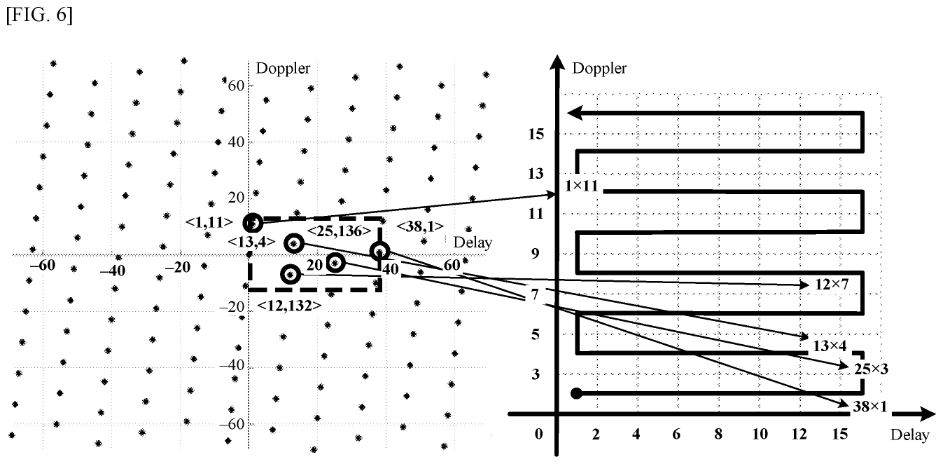

For ease of understanding, FIG. 6 is a diagram of mapping a ZC root sequence to a delay-Doppler domain coordinate system. In FIG. 6, a sequence length N=139 and a root sequence number u=11 are used as an example. In FIG. 6, the delay-Doppler domain coordinate system is divided into eight intervals in delay domain, where the eight intervals are [0,2), [2,4), [4,6), [6,8), [8,10), [10,12), [12,15), and [15, +∞); and is divided into eight intervals in Doppler domain, where the eight intervals are [0,3), [3,5), [5,7), [7,9), [9,11), [11,13), [13,15), and [15, +∞). A candidate peak point set [symbol] ={ [symbol] , [symbol] , [symbol] , [symbol] , [symbol] }, and a candidate physical root sequence number set Δ_{T,k}_{ᵢ}×Δ_{F,l}_{ᵢ}={Δ_{T,1}×Δ_{F,1}, Δ_{T,2}×Δ_{F,2}, Δ_{T,3}×Δ_{F,3}, Δ_{T,4}×Δ_{F,4}, Δ_{T,5}×Δ_{F,5}}={1×11,12×7,13×4,38×1,25×3}. Physical root sequence number sets are sorted according to the fourth rule, and after sorting, Δ_{T,k}_{ᵢ}×Δ_{F,l}_{ᵢ}={38×1,25×3,13×4,12×7,1×11}.

According to the fourth rule, determining the physical root sequence number set based on each candidate physical root sequence number set includes: selecting i that maximizes lᵢ from | [symbol] | candidate physical root sequence number sets as the physical root sequence number set; and when lᵢ in a plurality of candidate physical root sequence number sets are the same and are even numbers, determining i that maximizes kᵢ as the physical root sequence number set; or when lᵢ in a plurality of candidate physical root sequence number sets are the same and are odd numbers, determining i that minimizes k; as the physical root sequence number set. The example in FIG. 6 is still used. Δ_{T,5}×Δ_{F,5}=1×11 in a maximum zero ambiguity zone is finally mapped to an interval [0,2)×[11,13).

Similar to obtaining the mapping relationship between the logical root sequence number and the physical root sequence number according to the first rule, the mapping relationship between the logical root sequence number and the physical root sequence number may also be obtained according to the fourth rule. For example, it is assumed that a sequence length N=13, maximum round-trip time intervals Δ_{T,1}=0, Δ_{T,2}=2, Δ_{T,3}=4, Δ_{T,4}=6, and maximum Doppler frequency shift intervals Δ_{F,1}=0, Δ_{F,2}=3, Δ_{F,3}=5, Δ_{F,4}=7. The mapping relationship that is between the logical root sequence number and the physical root sequence number and that is obtained according to the fourth rule may be shown in Table 5. It should be noted that Table 5 is merely an example.

TABLE 5

| Logical root sequence number | Physical root sequence number |
|---|---|
| 0-1 | 1, 12 |
| 2-3 | 2, 11 |
| 4-5 | 3, 10 |
| 6-7 | 4, 9 |
| 8-11 | 5, 8, 6, 7 |

According to any one of the first rule to the fourth rule, a plurality of consecutive root sequence numbers in all the physical root sequence numbers may correspond to a same cubic metric interval, a same maximum round-trip time interval, and a same maximum Doppler frequency shift interval. In this way, even in a high-speed movement scenario, all physical root sequence numbers in any physical root sequence number set are available, thereby improving sequence utilization.

The terminal device may determine, based on the mapping relationship between the logical root sequence number and the physical root sequence number, a physical root sequence to be used to initiate random access. Correspondingly, the network device may determine, based on the mapping relationship between the logical root sequence number and the physical root sequence number, the physical root sequence to be used by the terminal device to initiate random access.

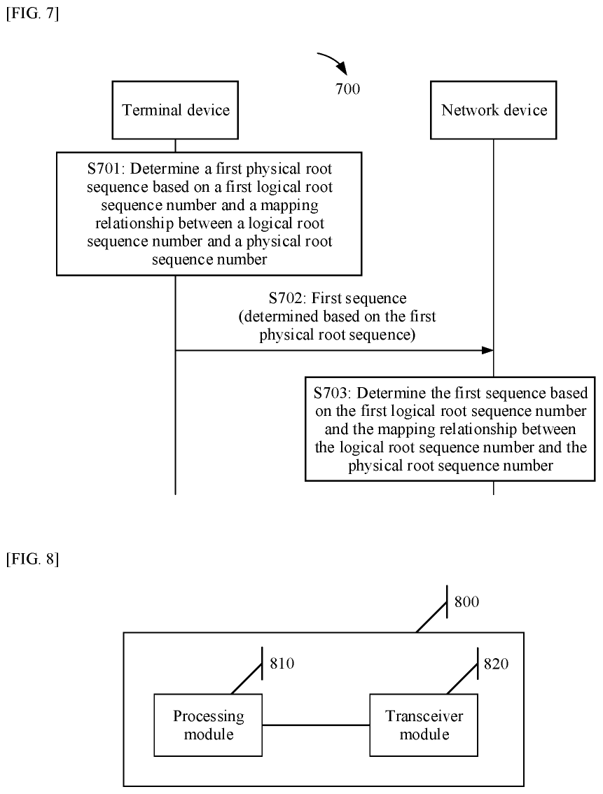

FIG. 7 illustrates a schematic flowchart of a communication method 700 according to an embodiment of this application. The communication method 700 provided in FIG. 7 relates to interaction between two communication apparatuses. The two communication apparatuses are a first communication apparatus and a second communication apparatus. For example, the first communication apparatus is a network device, and the second communication apparatus is a terminal device. Steps performed by the network device may be implemented by a RAN device, or may be implemented by a component (for example, a module like a control board (chip), a baseband chip, another processing unit, or a processor) in the RAN device. For example, the network device may be 110a or 110b in FIG. 1, or may be a chip (system) in 110a or 110b in FIG. 1. Steps performed by the terminal device may be implemented by the terminal device, or may be implemented by a component (for example, a module like a chip, a processing unit, or a processor) in the terminal device. The terminal device may be any terminal device in 120a to 120j shown in FIG. 1, or may be a chip (system) in any terminal device in 120a to 120j in FIG. 1. As shown in FIG. 7, the method 700 shown in FIG. 7 includes the following steps.

S701: The terminal device determines a first physical root sequence based on a first logical root sequence number and a mapping relationship between a logical root sequence number and a physical root sequence number.

In this embodiment of this application, in the mapping relationship between the logical root sequence number and the physical root sequence number, root sequences in any physical root sequence set correspond to a same cubic metric interval, a same maximum round-trip time interval, and a same maximum Doppler frequency shift interval. For example, root sequences in a first physical root sequence set correspond to a same cubic metric interval, a same maximum round-trip time interval, and a same maximum Doppler frequency shift interval. The first physical root sequence may be a physical root sequence in the first physical root sequence set. The mapping relationship is obtained according to any one of the first rule to the fourth rule. For details, refer to the foregoing related content. Details are not described herein again. For example, the mapping relationship between the logical root sequence number and the physical root sequence number may be shown in Table 2, Table 3, Table 4, or Table 5. It may be understood that Table 2, Table 3, Table 4, or Table 5 is merely an example.

When initiating a reference signal, the terminal device may determine a physical root sequence (namely, the first physical root sequence in this specification) used to generate the reference signal. For example, the terminal device may determine, based on a first logical root sequence number of a cell and the mapping relationship between the logical root sequence number and the physical root sequence number, a first physical root sequence number corresponding to the first logical root sequence number. The first physical root sequence number indicates the first physical root sequence.

It may be understood that before S701, the terminal device may determine the first logical root sequence number. In an implementation, the first logical root sequence number may be a logical root sequence number stored by the terminal device. In another implementation, the first logical root sequence number is indicated by the network device to the terminal device. For example, the network device sends indication information to the terminal device, and the indication information may indicate the first logical root sequence number.

S702: The terminal device sends a first sequence, where the first sequence is determined based on the first physical root sequence.

Correspondingly, the network device receives the first sequence. The first sequence may be a random access preamble or a reference signal sequence. The terminal device determines the first physical root sequence, and may perform an operation like a cyclic shift on the first physical root sequence to obtain the first sequence. After obtaining the first sequence, the terminal device sends the first sequence to the network device.

S703: The network device determines the first sequence based on the first logical root sequence number and the mapping relationship between the logical root sequence number and the physical root sequence number.

After receiving the first sequence, the network device may determine content of the first sequence based on the first logical root sequence number and the mapping relationship between the logical root sequence number and the physical root sequence number, to respond to the first sequence.

In a possible implementation, the network device may alternatively send a reference signal to the terminal device based on the mapping relationship between the logical root sequence number and the physical root sequence number. For example, when initiating the reference signal, the network device may determine a physical root sequence (for example, a second physical root sequence) used to generate the reference signal. The network device may determine, based on a second logical root sequence number of the cell and the mapping relationship between the logical root sequence number and the physical root sequence number, a second physical root sequence number corresponding to the second logical root sequence number, generate the reference signal based on the second physical root sequence number, and send the reference signal.

In the embodiment provided above, the method provided in embodiments of this application is described from a perspective of interaction between the terminal device and the network device. Steps performed by the terminal device may be implemented by different functional entities included in the terminal device. Steps performed by the network device may be implemented by different functional entities included in the network device. For example, the network device may be in a CU-DU architecture, a CU may generate indication information, and a DU may send the indication information. To implement functions in the method provided in the foregoing embodiments of this application, the terminal device and the network device may include a hardware structure and/or a software module, and the foregoing functions are implemented in a form of the hardware structure, the software module, or a combination of the hardware structure and the software module. Whether a function in the foregoing functions is performed by using the hardware structure, the software module, or the combination of the hardware structure and the software module depends on particular applications and design constraints of the technical solutions.

The following describes communication apparatuses for implementing the foregoing methods in embodiments of this application with reference to the accompanying drawings. Therefore, all the foregoing content may be used in the following embodiments. Repeated content is not described again.

FIG. 8 is a block diagram of a communication apparatus 800 according to an embodiment of this application. The communication apparatus 800 may be the network device or the terminal device in the foregoing embodiments. For example, the communication apparatus 800 may be the network device or the terminal device in FIG. 1. Alternatively, the communication apparatus 800 is a chip (system) in the network device or a chip (system) in the terminal device. Alternatively, the communication apparatus 800 is a software module in the network device or the terminal device. The communication apparatus 800 may correspondingly implement functions or steps implemented by the terminal device or the network device in the foregoing method embodiments. The communication apparatus 800 may include a processing module 810 and a transceiver module 820. Optionally, a storage module may be further included. The storage module may be configured to store instructions (code or a program) and/or data. The storage module may be, for example, a memory. The processing module 810 and the transceiver module 820 may be coupled to the storage module. For example, the processing module 810 may read the instructions (the code or the program) and/or the data in the storage module, to implement the corresponding method. When the communication apparatus 800 is a chip in the terminal device, the storage module may be a storage module in the chip, for example, a register or a cache. For example, the storage module may alternatively be a storage module that is in the network device/terminal device and that is located outside the chip, for example, a read-only memory (read-only memory, ROM), another type of static storage device that can store static information and instructions, or a random access memory (random access memory, RAM). The foregoing units may be independently disposed, or may be partially or completely integrated.

In a possible implementation, the processing module 810 may be a processor or a controller, for example, may be a general-purpose central processing unit (central processing unit, CPU), a general-purpose processor, digital signal processing (digital signal processing, DSP), an application-specific integrated circuit (application-specific integrated circuit, ASIC), a field programmable gate array (field programmable gate array, FPGA) or another programmable logic device, a transistor logic device, a hardware component, or any combination thereof. The processor may implement or execute various example logical blocks, modules, and circuits described with reference to content disclosed in this application. Alternatively, the processor may be a combination of processors implementing a computing function, for example, a combination of one or more microprocessors, or a combination of a DSP and a microprocessor. The transceiver module 820 is a transceiver, an interface circuit, a bus, a pin, or another possible communication interface, and is configured to receive a signal from another apparatus. For example, when the apparatus is implemented in a form of chip, the transceiver module 820 is an interface circuit used by the chip to receive a signal from another chip or apparatus, or is an interface circuit used by the chip to send a signal to another chip or apparatus.

In some possible implementations, the communication apparatus 800 can accordingly implement the behavior and the function of the terminal device in the foregoing method embodiments. The communication apparatus 800 may be a terminal device, may be a component (for example, a chip or a circuit) used in the terminal device, may be a chip or a chip group in the terminal device or a part that is of the chip and that is configured to perform a related method function, or may be a software module that can implement the method performed by the terminal device in the foregoing methods (for example, any method in the communication method 700). This is not limited.

For example, the communication apparatus 800 implements the method performed by the terminal device in the embodiment in FIG. 7. The transceiver module 820 may be configured to perform S702 in the embodiment shown in FIG. 7, and/or configured to support another process of the technology described in this specification. The processing module 810 may be configured to perform S701 in the embodiment shown in FIG. 7, and/or configured to support another process of the technology described in this specification.

In an implementation, the processing module 810 is configured to determine a first physical root sequence based on a first logical root sequence number and a mapping relationship between a logical root sequence number and a physical root sequence number. The transceiver module 820 is configured to send a first sequence, where the first sequence is determined based on the first physical root sequence, and the first physical root sequence belongs to a first physical root sequence set. Root sequences in the first physical root sequence set correspond to a same cubic metric interval, a same maximum round-trip time interval, and a same maximum Doppler frequency shift interval.

In another implementation, the processing module 810 may be configured to: sort all physical root sequence numbers, and set a logical root sequence number for each sorted physical root sequence number, to obtain the mapping relationship between the logical root sequence number and the physical root sequence number. a plurality of consecutive physical root sequence numbers in all the physical root sequence numbers each correspond to a same cubic metric interval, a same maximum round-trip time interval, and a same maximum Doppler frequency shift interval. The logical root sequence number is a position index of the corresponding physical root sequence number in all the physical root sequence numbers.

In an optional implementation, the transceiver module 820 is further configured to receive indication information, where the indication information indicates the first logical root sequence number, and the first logical root sequence number indicates a sequence number of the first physical root sequence.

In an optional implementation, all the physical root sequence numbers are divided into a plurality of physical root sequence number sets, and the plurality of physical root sequence number sets are obtained according to the following division rule:
dividing all the physical root sequence numbers into a low cubic metric group and a high cubic metric group by using a first cubic metric as a boundary, where cubic metrics of physical root sequences indicated by all physical root sequence numbers in the low cubic metric group do not exceed the first cubic metric, and cubic metrics of physical root sequences indicated by all physical root sequence numbers in the high cubic metric group exceed the first cubic metric;
for the low cubic metric group and the high cubic metric group, dividing all physical root sequence numbers in each group into a plurality of physical root sequence number sets by using a maximum round-trip time and a maximum Doppler frequency shift as a boundary; and
arranging physical root sequence numbers in each of the plurality of physical root sequence number sets in a cubic metric order.

In an optional implementation, arranging the physical root sequence numbers in each of the plurality of physical root sequence number sets in the cubic metric order includes: first sorting physical root sequence number sets in the low cubic metric group, and then sorting physical root sequence number sets in the high cubic metric group; for the low cubic metric group, performing, starting from a last physical root sequence number set, alternate arrangement in ascending and descending order of cubic metrics, where arrangement is performed in the last physical root sequence number set in ascending order of cubic metrics; and for the high cubic metric group, performing, starting from a first physical root sequence number set, alternate arrangement in ascending and descending order of cubic metrics, where arrangement is performed in the first physical root sequence number set in ascending order of cubic metrics.

In an optional implementation, the processing module 810 is further configured to determine a candidate peak point of an ambiguity function of a physical root sequence corresponding to each physical root sequence number. In a delay-Doppler coordinate system, the candidate peak point satisfies the following: a delay spacing between the candidate peak point and a coordinate origin in the delay-Doppler coordinate system is not greater than a delay spacing between the coordinate origin and any peak point other than the coordinate origin; and/or a Doppler spacing between the candidate peak point and the coordinate origin in the delay-Doppler coordinate system is not greater than a Doppler spacing between the coordinate origin and the any peak point other than the coordinate origin. A horizontal axis in the delay-Doppler coordinate system indicates delay domain, and a vertical axis in the delay-Doppler coordinate system indicates Doppler domain.

For example, a set [symbol] ={ [symbol] , [symbol] , . . . , [symbol] } of coordinates of candidate peak points of the ambiguity function satisfies the following:

$$𝒮 = \{ 〈 τ , u τ mod N 〉 \vert min \{ \pm u τ mod N \} < {min}_{n = 1 , 2 , … , τ - 1} \{ \pm un mod N \} , τ ∈ \{ 1 , 2 , … , ( N - 1 ) / 2 \} \}$$

N indicates a sequence length of the first physical root sequence, u indicates the first physical root sequence number, τᵢ indicates a delay coordinate of an i^{th} candidate peak point in the set [symbol] of the coordinates of the candidate peak points of the ambiguity function, vᵢ indicates a Doppler coordinate of the i^{th} candidate peak point in the set S of the coordinates of the candidate peak points of the ambiguity function, 0≤i≤| [symbol] |−1, and the operator |·| indicates cardinality of the set.

In an optional implementation, the processing module 810 is further configured to: determine an i^{th} candidate physical root sequence number set Δ_{T,k}_{ᵢ}×Δ_{F,l}_{ᵢ} based on coordinates [symbol] of the i^{th} candidate peak point in the set S; and determine, based on each candidate physical root sequence number set, a physical root sequence number set [Δ_{T,k}, Δ_{T,k+1})×[Δ_{F,l}, Δ_{F,l+1}) corresponding to the physical root sequence number, where k∈{0,1, . . . . K−1}, l∈={0,1, . . . L−1}. A maximum round-trip time interval [Δ_{T,k}_{ᵢ}, Δ_{T,k}_{ᵢ}₊₁) and a maximum Doppler frequency shift interval [Δ_{F,l}_{ᵢ}, Δ_{F,l}_{ᵢ}₊₁) that correspond to Δ_{T,k}_{ᵢ}×Δ_{F,l}_{ᵢ} satisfy the following:

$${τ}_{i} \times min \{ {v}_{i} , N - {v}_{i} \} ∈ [ {Δ}_{T , {k}_{i}} , {Δ}_{T , {k}_{i} + 1} ) \times [ {Δ}_{F , {l}_{i}} , {Δ}_{F , {l}_{i} + 1} )$$

[Δ_{T,0}, Δ_{T,1}), [Δ_{T,1}, Δ_{T,2}), . . . , [Δ_{T,K-1}, +∞) indicates K preset maximum round-trip time intervals in the physical root sequence number set, [Δ_{F,0}, Δ_{F,1}), [Δ_{F,1}, Δ_{F,2}), . . . , [Δ_{F,L-1}, +∞) indicates L preset maximum Doppler frequency shift intervals in the physical root sequence number set, 0≤kᵢ≤K−1, 0≤lᵢ≤L−1, and 0≤i≤| [symbol] |−1.

In an optional implementation, when a quantity K of maximum round-trip time intervals is equal to a quantity L of maximum Doppler frequency shift intervals, an arrangement order of the plurality of physical root sequence number sets satisfies the following: K×L physical root sequence number sets are sorted in ascending order of max {k, l}, where when max {k, l} are the same and are even numbers, k are sorted in ascending order, and for any k, l are sorted in descending order; or when max {k, l} are the same and are odd numbers, l are sorted in ascending order, and for any l, k are sorted in descending order.

Optionally, the processing module 810 is specifically configured to: select i that maximizes max {kᵢ, lᵢ} from | [symbol] | candidate physical root sequence number sets as the physical root sequence number set; when max {kᵢ, lᵢ} in a plurality of candidate physical root sequence number sets are the same and are even numbers, determine i that minimizes lᵢ as the physical root sequence number set, and if lᵢ in the plurality of candidate physical root sequence number sets are the same, determine i that maximizes kᵢ as the physical root sequence number set; or when max {kᵢ, lᵢ} in a plurality of candidate physical root sequence number sets are the same and are odd numbers, determine i that minimizes kᵢ as the physical root sequence number set, and if kᵢ in the plurality of candidate physical root sequence number sets are the same, determine i that maximizes lᵢ as the physical root sequence number set.

In an optional implementation, when a quantity K of maximum round-trip time intervals is equal to a quantity L of maximum Doppler frequency shift intervals, an arrangement order of the plurality of physical root sequence number sets satisfies the following: K×L physical root sequence number sets are sorted in ascending order of max {k, l}, where when max {k, l} are the same and are even numbers, l are sorted in ascending order, and for any l, k are sorted in descending order; or when max {k, l} are the same and are odd numbers, k are sorted in ascending order, and for any k, l are sorted in descending order.

Optionally, the processing module 810 is specifically configured to: select i that maximizes max {kᵢ, lᵢ} from | [symbol] | candidate physical root sequence number sets as the physical root sequence number set; when max {kᵢ, lᵢ} in a plurality of candidate physical root sequence number sets are the same and are even numbers, determine i that minimizes kᵢ as the physical root sequence number set, and if kᵢ in the plurality of candidate physical root sequence number sets are the same, determine i that maximizes lᵢ as the physical root sequence number set; or when max {kᵢ, lᵢ} in a plurality of candidate physical root sequence number sets are the same and are odd numbers, determine i that minimizes lᵢ as the physical root sequence number set, and if lᵢ in the plurality of candidate physical root sequence number sets are the same, determine i that maximizes kᵢ as the physical root sequence number set.

In an optional implementation, an arrangement order of the plurality of physical root sequence number sets satisfies the following: K×L physical root sequence number sets are sorted in ascending order of k, where when k are the same and are even numbers, I are sorted in ascending order; or when k are the same and are odd numbers, I are sorted in descending order.

Optionally, the processing module 810 is specifically configured to: select i that maximizes kᵢ from | [symbol] | candidate physical root sequence number sets as the physical root sequence number set; and when kᵢ in a plurality of candidate physical root sequence number sets are the same and are even numbers, determine i that maximizes lᵢ as the physical root sequence number set; or when kᵢ in a plurality of candidate physical root sequence number sets are the same and are odd numbers, determine i that minimizes lᵢ as the physical root sequence number set.

In an optional implementation, an arrangement order of the plurality of physical root sequence number sets satisfies the following: K×L physical root sequence number sets are sorted in ascending order of l, where when l are the same and are even numbers, k are sorted in ascending order; or when l are the same and are odd numbers, k are sorted in descending order.

Optionally, the processing module 810 is specifically configured to: select i that maximizes lᵢ from | [symbol] | candidate physical root sequence number sets as the physical root sequence number set; and when lᵢ in a plurality of candidate physical root sequence number sets are the same and are even numbers, determine i that maximizes k; as the physical root sequence number set; or when lᵢ in a plurality of candidate physical root sequence number sets are the same and are odd numbers, determine i that minimizes k; as the physical root sequence number set.

For another example, the communication apparatus 800 implements the method performed by the network device in the embodiment in FIG. 7. The transceiver module 820 may be configured to perform S702 in the embodiment shown in FIG. 7, and/or configured to support another process of the technology described in this specification. The processing module 810 may be configured to perform S703 in the embodiment shown in FIG. 7, and/or configured to support another process of the technology described in this specification.

In an implementation, the transceiver module 820 is configured to receive a first sequence, where the first sequence is determined based on a first physical root sequence. The processing module 810 is configured to determine the first sequence based on a first logical root sequence number and a mapping relationship between a logical root sequence number and a physical root sequence number. The first logical root sequence number indicates the first physical root sequence. The first physical root sequence belongs to a first physical root sequence set, and root sequences in the first physical root sequence set correspond to a same cubic metric interval, a same maximum round-trip time interval, and a same maximum Doppler frequency shift interval. In another implementation, the processing module 810 is configured to: sort all physical root sequence numbers, where a plurality of consecutive physical root sequence numbers in all the physical root sequence numbers each correspond to a same cubic metric interval, a same maximum round-trip time interval, and a same maximum Doppler frequency shift interval; and set a logical root sequence number for each sorted physical root sequence number, to obtain a mapping relationship between the logical root sequence number and the physical root sequence number, where the logical root sequence number is a position index of the corresponding physical root sequence number in all the physical root sequence numbers.

In an optional implementation, the transceiver module 820 is further configured to send indication information, where the indication information indicates the first logical root sequence number, and the first logical root sequence number indicates a sequence number of the first physical root sequence.

In an optional implementation, all the physical root sequence numbers are divided into a plurality of physical root sequence number sets, and the plurality of physical root sequence number sets are obtained according to the following division rule:
dividing all the physical root sequence numbers into a low cubic metric group and a high cubic metric group by using a first cubic metric as a boundary, where cubic metrics of physical root sequences indicated by all physical root sequence numbers in the low cubic metric group do not exceed the first cubic metric, and cubic metrics of physical root sequences indicated by all physical root sequence numbers in the high cubic metric group exceed the first cubic metric;
for the low cubic metric group and the high cubic metric group, dividing all physical root sequence numbers in each group into a plurality of physical root sequence number sets by using a maximum round-trip time and a maximum Doppler frequency shift as a boundary; and
arranging physical root sequence numbers in each of the plurality of physical root sequence number sets in a cubic metric order.

In an optional implementation, arranging the physical root sequence numbers in each of the plurality of physical root sequence number sets in the cubic metric order includes: first sorting physical root sequence number sets in the low cubic metric group, and then sorting physical root sequence number sets in the high cubic metric group; for the low cubic metric group, performing, starting from a last physical root sequence number set, alternate arrangement in ascending and descending order of cubic metrics, where arrangement is performed in the last physical root sequence number set in ascending order of cubic metrics; and for the high cubic metric group, performing, starting from a first physical root sequence number set, alternate arrangement in ascending and descending order of cubic metrics, where arrangement is performed in the first physical root sequence number set in ascending order of cubic metrics.

In an optional implementation, the processing module 810 is further configured to determine a candidate peak point of an ambiguity function of a physical root sequence corresponding to each physical root sequence number. In a delay-Doppler coordinate system, the candidate peak point satisfies the following: a delay spacing between the candidate peak point and a coordinate origin in the delay-Doppler coordinate system is not greater than a delay spacing between the coordinate origin and any peak point other than the coordinate origin; and/or a Doppler spacing between the candidate peak point and the coordinate origin in the delay-Doppler coordinate system is not greater than a Doppler spacing between the coordinate origin and the any peak point other than the coordinate origin. A horizontal axis in the delay-Doppler coordinate system indicates delay domain, and a vertical axis in the delay-Doppler coordinate system indicates Doppler domain.

For example, a set [symbol] ={ [symbol] , [symbol] , . . . [symbol] } of coordinates of candidate peak points of the ambiguity function satisfies the following:

$$𝒮 = \{ 〈 τ , u τ mod N 〉 \vert min \{ \pm u τ mod N \} < {min}_{n = 1 , 2 , … , τ - 1} \{ \pm un mod N \} , τ ∈ \{ 1 , 2 , … , ( N - 1 ) / 2 \} \}$$

N indicates a sequence length of the first physical root sequence, u indicates the first physical root sequence number, τᵢ indicates a delay coordinate of an i^{th} candidate peak point in the set S of the coordinates of the candidate peak points of the ambiguity function, vᵢ indicates a Doppler coordinate of the i^{th} candidate peak point in the set S of the coordinates of the candidate peak points of the ambiguity function, 0≤i≤| [symbol] |−1, and the operator |·| indicates cardinality of the set.

In an optional implementation, the processing module 810 is further configured to: determine an i^{th} candidate physical root sequence number set Δ_{T,k}_{ᵢ}×Δ_{F,l}_{ᵢ} based on coordinates [symbol] of the i^{th} candidate peak point in the set S; and determine, based on each candidate physical root sequence number set, a physical root sequence number set [Δ_{T,k}, Δ_{T,k+1})×[Δ_{F,l}, Δ_{F,l+1}) corresponding to the physical root sequence number, where k∈{0,1, . . . K−1}, l∈={0,1, . . . L−1}. A maximum round-trip time interval [Δ_{T,k}_{ᵢ}, Δ_{T,k}_{ᵢ}₊₁) and a maximum Doppler frequency shift interval [Δ_{F,l}_{ᵢ}, Δ_{F,l}_{ᵢ}₊₁) that correspond to Δ_{T,k}_{ᵢ}×Δ_{F,l}_{ᵢ} satisfy the following: τᵢ×min {vᵢ, N−vᵢ}∈[Δ_{T,k}_{ᵢ}, Δ_{T,k}_{ᵢ}₊₁)×[Δ_{F,l}_{ᵢ}, Δ_{F,l}_{ᵢ}₊₁)

[Δ_{T,0}, Δ_{T,1}), [Δ_{T,1}, Δ_{T,2}), . . . , [Δ_{T,K-1}, +∞) indicates K preset maximum round-trip time intervals in the physical root sequence number set, [Δ_{F,0}, Δ_{F,1}), [Δ_{F,1}, Δ_{F,2}), . . . , [Δ_{F,L-1}, +∞) indicates L preset maximum Doppler frequency shift intervals in the physical root sequence number set, 0≤kᵢ≤K−1, 0≤lᵢ≤L−1, and 0≤i≤| [symbol] |−1.

In an optional implementation, when a quantity K of maximum round-trip time intervals is equal to a quantity L of maximum Doppler frequency shift intervals, an arrangement order of the plurality of physical root sequence number sets satisfies the following: K x L physical root sequence number sets are sorted in ascending order of max {k, l}, where when max {k, l} are the same and are even numbers, k are sorted in ascending order, and for any k, l are sorted in descending order; or when max {k, l} are the same and are odd numbers, I are sorted in ascending order, and for any l, k are sorted in descending order.

Optionally, the processing module 810 is specifically configured to: select i that maximizes max {kᵢ, lᵢ} from | [symbol] | candidate physical root sequence number sets as the physical root sequence number set; when max {kᵢ, lᵢ} in a plurality of candidate physical root sequence number sets are the same and are even numbers, determine i that minimizes lᵢ as the physical root sequence number set, and if lᵢ in the plurality of candidate physical root sequence number sets are the same, determine i that maximizes kᵢ as the physical root sequence number set; or when max {kᵢ, lᵢ} in a plurality of candidate physical root sequence number sets are the same and are odd numbers, determine i that minimizes kᵢ as the physical root sequence number set, and if kᵢ in the plurality of candidate physical root sequence number sets are the same, determine i that maximizes lᵢ as the physical root sequence number set.

In an optional implementation, when a quantity K of maximum round-trip time intervals is equal to a quantity L of maximum Doppler frequency shift intervals, an arrangement order of the plurality of physical root sequence number sets satisfies the following: K×L physical root sequence number sets are sorted in ascending order of max {k, l}, where when max {k, l} are the same and are even numbers, l are sorted in ascending order, and for any l, k are sorted in descending order; or when max {k, l} are the same and are odd numbers, k are sorted in ascending order, and for any k, l are sorted in descending order.

Optionally, the processing module 810 is specifically configured to: select i that maximizes max {kᵢ, lᵢ} from | [symbol] | candidate physical root sequence number sets as the physical root sequence number set; when max {kᵢ, lᵢ} in a plurality of candidate physical root sequence number sets are the same and are even numbers, determine i that minimizes kᵢ as the physical root sequence number set, and if kᵢ in the plurality of candidate physical root sequence number sets are the same, determine i that maximizes lᵢ as the physical root sequence number set; or when max {kᵢ, lᵢ} in a plurality of candidate physical root sequence number sets are the same and are odd numbers, determine i that minimizes lᵢ as the physical root sequence number set, and if lᵢ in the plurality of candidate physical root sequence number sets are the same, determine i that maximizes kᵢ as the physical root sequence number set.

In an optional implementation, an arrangement order of the plurality of physical root sequence number sets satisfies the following: K×L physical root sequence number sets are sorted in ascending order of k, where when k are the same and are even numbers, l are sorted in ascending order; or when k are the same and are odd numbers, I are sorted in descending order.

Optionally, the processing module 810 is specifically configured to: select i that maximizes kᵢ from | [symbol] | candidate physical root sequence number sets as the physical root sequence number set; and when kᵢ in a plurality of candidate physical root sequence number sets are the same and are even numbers, determine i that maximizes lᵢ as the physical root sequence number set; or when kᵢ in a plurality of candidate physical root sequence number sets are the same and are odd numbers, determine i that minimizes lᵢ as the physical root sequence number set.

In an optional implementation, an arrangement order of the plurality of physical root sequence number sets satisfies the following: K×L physical root sequence number sets are sorted in ascending order of l, where when I are the same and are even numbers, k are sorted in ascending order; or when I are the same and are odd numbers, k are sorted in descending order.

Optionally, the processing module 810 is specifically configured to: select i that maximizes lᵢ from | [symbol] | candidate physical root sequence number sets as the physical root sequence number set; and when lᵢ in a plurality of candidate physical root sequence number sets are the same and are even numbers, determine i that maximizes kᵢ as the physical root sequence number set; or when lᵢ in a plurality of candidate physical root sequence number sets are the same and are odd numbers, determine i that minimizes kᵢ as the physical root sequence number set.

When the communication apparatus 800 is a chip-type apparatus or circuit, the transceiver module may be an input/output circuit and/or a communication interface, and the processing module is an integrated processor, a microprocessor, or an integrated circuit.

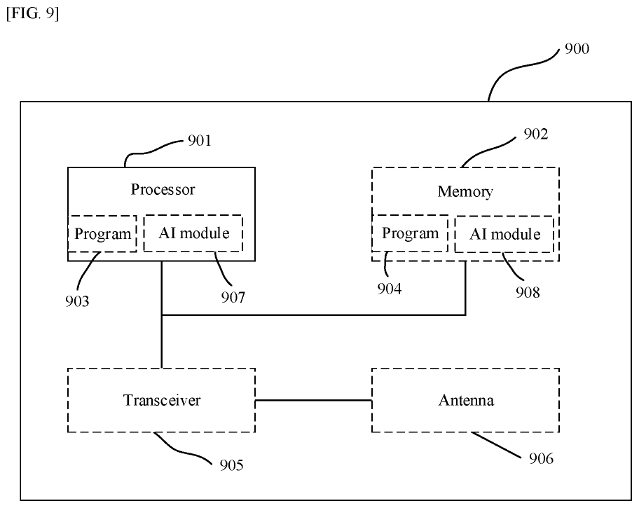

FIG. 9 is a block diagram of a communication apparatus 900 according to an embodiment of this application. The communication apparatus 900 may be the network device or the terminal device in the foregoing embodiments. For example, the communication apparatus 900 may be the network device or the terminal device in FIG. 1. Alternatively, the communication apparatus 900 is a chip (system) in the network device or the terminal device. In this embodiment of this application, the chip system may include a chip, or may include a chip and another discrete component. For a specific function, refer to the description in the foregoing method embodiment.

The communication apparatus 900 includes one or more processors 901, configured to implement or support the communication apparatus 900 in implementing the function of the terminal device or the network device in the methods provided in embodiments of this application. For details, refer to detailed descriptions in the method example. Details are not described herein again. The processor 901 may also be referred to as a processing unit or a processing module, and may implement a specific control function. The processor 901 may be a general-purpose processor, a dedicated processor, or the like. For example, the processor 901 includes a baseband processor, a central processing unit, an application processor, a modem processor, a graphics processing unit, an image signal processor, a digital signal processor, a video codec processor, a controller, a memory, and/or a neural network processor. The baseband processor may be configured to process a communication protocol and communication data. The central processing unit may be configured to: control the communication apparatus 900 (for example, the network apparatus or the terminal apparatus), execute a software program, and/or process data. Different processors may be independent components, or may be integrated into one or more processors, for example, integrated into one or more application-specific integrated circuits.

In a design, the processor 901 may include a program 903 (which may also be referred to as code or instructions sometimes). The program 903 may be run on the processor 901, to enable the communication apparatus 900 to perform the method described in the following embodiments. In another possible design, the communication apparatus 900 includes a circuit (not shown in FIG. 9), and the circuit is configured to implement the function of the network device or the terminal device in the foregoing embodiments.

In a design, the communication apparatus 900 may include one or more memories 902, and the memory 902 stores a program 904 (which may also be referred to as code or instructions sometimes). The program 904 may be run on the processor 901, so that the communication apparatus 900 performs the method described in the foregoing method embodiments, for example, the procedures shown in one or more of FIG. 7.

In a design, the processor 901 and/or the memory 902 may include an artificial intelligence (artificial intelligence, AI) module 907 and an AI module 908. The AI module is configured to implement an AI-related function. The AI module may be implemented by using software, hardware, or a combination of software and hardware. For example, the AI module may include a RAN intelligent controller (RAN intelligent controller, RIC) module. For example, the AI module may be a near-real-time RIC or a non-real-time RIC.

In a possible design, the processor 901 and/or the memory 902 may further store data. The processor and the memory may be separately disposed, or may be integrated together.

In a possible design, the communication apparatus 900 may further include a transceiver 905 and/or an antenna 906. The processor 901 may sometimes also be referred to as a processing unit, and controls the communication apparatus 900. The transceiver 905 may sometimes also be referred to as a transceiver unit, a transceiver machine, a transceiver circuit, a transceiver device, or the like, and is configured to implement a transceiver function of the communication apparatus through the antenna 906.

In a possible design, the communication apparatus 900 may further include one or more of the following components: a wireless communication module, an audio module, an interface for external memory, an internal memory, a universal serial bus (universal serial bus, USB) interface, a power management module, an antenna, a speaker, a microphone, an input/output module, a sensor module, a motor, a camera, a display, or the like. It may be understood that in some embodiments, the communication apparatus 900 may include more or fewer components, or some components are integrated, or some components are split. These components may be implemented by hardware, software, or a combination of software and hardware.

The communication apparatus in the foregoing embodiments may be a terminal device (or a network device), may be a circuit, or may be a chip used in the terminal device (or the network device) or another combined device, component, or the like that has the terminal device (or the network device). When the communication apparatus is a terminal device (or a network device), the transceiver module may be a transceiver, and may include an antenna, a radio frequency circuit, and the like, and the processing module may be a processor, for example, a CPU. When the communication apparatus is a component having a function of the terminal device (or the network device), the transceiver module may be a radio frequency unit, and the processing module may be a processor. When the communication apparatus is a chip system, the communication apparatus may be an FPGA, a dedicated ASIC, a system on chip (system on chip, SoC), a CPU, a network processor (network processor, NP), a DSP, a microcontroller unit (microcontroller unit, MCU), a programmable controller (programmable logic device, PLD), or another integrated chip. The processing module may be a processor of the chip system. The transceiver module or a communication interface may be an input/output interface or an interface circuit of the chip system. For example, the interface circuit may be a code/data read/write interface circuit. The interface circuit may be configured to receive code instructions (where the code instructions are stored in the memory, and may be directly read from the memory, or may be read from the memory through another component) and transmit the code instructions to the processor. The processor may be configured to run the code instructions to perform the method in the foregoing method embodiments. For another example, the interface circuit may alternatively be a signal transmission interface circuit between a communication processor and the transceiver machine.

An embodiment of this application further provides a communication system. Specifically, the communication system includes a network device and a terminal device. For example, the communication system includes a terminal device and a network device that are configured to implement related functions in FIG. 7. For details, refer to related descriptions in the foregoing method embodiments. Details are not described herein again.

An embodiment of this application further provides a computer-readable storage medium, including instructions. When the instructions are run on a computer, the computer is enabled to perform the method performed by the terminal device or the network device in FIG. 7.

An embodiment of this application further provides a computer program product, including instructions. When the instructions are run on a computer, the computer is enabled to perform the method performed by the terminal device or the network device in FIG. 7.

An embodiment of this application provides a chip system. The chip system includes a processor, may further include a memory, and is configured to implement a function of the terminal apparatus or the network apparatus in the foregoing methods. The chip system may include a chip, or may include a chip and another discrete component.

To implement the functions of the communication apparatuses in FIG. 8 and FIG. 9, an embodiment of this application further provides a chip, including a processor, configured to support the communication apparatus in implementing the functions of the terminal device or the network device in the foregoing method embodiments. In a possible design, the chip is connected to a memory, or the chip includes a memory. The memory is configured to store a computer program or instructions and data that are necessary for the communication apparatus.

With reference to the foregoing content and the accompanying drawings, the following describes the technical solutions provided in embodiments of this application.

“When”, “in case”, and “if” all mean that an apparatus performs corresponding processing in an objective case, are not intended to limit time, do not require the apparatus to necessarily have a determining action during implementation, and do not mean other limitation. Unless otherwise specified, “if” and “in case” are interchangeable, and “when” and “in a case of” are interchangeable. “When” and “if”/“in case” are interchangeable.

Unless otherwise specified, a quantity of nouns represents “a singular noun or a plural noun”, namely, “one or more”. “A plurality of” means two or more. In view of this, “a plurality of” may alternatively be understood as “at least two” in embodiments of this application. “At least one” may be one or more, for example, at least one is one, two, or more. For example, including at least one means that one, two, or more are included, and which one or ones are included is not limited. For example, if at least one of A, B, and C is included, A, B, C, A and B, A and C, B and C, or A, B, and C may be included. Similarly, understandings of descriptions such as “at least one” are also similar. “At least one of the following” or a similar expression thereof indicates any combination of these items, including a single item or any combination of plural items. For example, “at least one of A, B, and C” includes A, B, C, AB, AC, BC, or ABC. The term “and/or” describes an association relationship between associated objects and represents that three relationships may exist. For example, A and/or B may represent the following three cases: Only A exists, both A and B exist, and only B exists. In addition, the character “/” generally indicates an “or” relationship between the associated objects.

Unless otherwise specified, ordinal numbers such as “first” and “second” in embodiments of this application are for distinguishing between a plurality of objects, but are not intended to limit orders, a time sequence, priorities, or importance of the plurality of objects. In addition, descriptions of “first” and “second” do not mean that objects are necessarily different.

It should be understood that sequence numbers of the foregoing processes do not mean execution orders in various embodiments of this application. The execution orders of the processes should be determined based on functions and internal logic of the processes, and should not be construed as any limitation on the implementation processes of embodiments of this application.

A person of ordinary skill in the art may be aware that, illustrative logical blocks (illustrative logical blocks) and steps (steps) described with reference to embodiments disclosed in this specification can be implemented by electronic hardware, computer software, or a combination of computer software and electronic hardware. Whether the functions are executed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiment is merely an example. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected based on actual requirements to achieve the objectives of the solutions of embodiments.

When the functions are implemented in a form of software functional unit and sold or used as an independent product, the functions may be stored in a computer-readable storage medium. Based on such an understanding, the technical solutions of this application essentially, or a part of the technical solutions may be embodied in a form of software product. The computer software product is stored in a storage medium, and includes several instructions for enabling a computer device (which may be a personal computer, a server, a network device, or the like) to perform all or a part of steps of the methods in embodiments of this application. The foregoing storage medium includes any medium, for example, a USB flash drive, a removable hard disk, a read-only memory (read-only memory, ROM), a RAM, a magnetic disk, or an optical disc, that can store program code.

It is clear that a person skilled in the art can make various modifications and variations to this application without departing from the protection scope of this application. This application is intended to cover these modifications and variations of this application provided that these modifications and variations fall within the scope of protection defined by the following claims of this application and their equivalent technologies.

1. A communication method, comprising:
determining a first physical root sequence based on a first logical root sequence number and a mapping relationship between a logical root sequence number and a physical root sequence number; and
sending a first sequence, wherein the first sequence is determined based on the first physical root sequence, the first physical root sequence belongs to a first physical root sequence set, and root sequences in the first physical root sequence set correspond to a same cubic metric interval, a same maximum round-trip time interval, and a same maximum Doppler frequency shift interval.

2. The method according to claim 1, wherein the method further comprises:
sorting a plurality of physical root sequence numbers, wherein a plurality of consecutive physical root sequence numbers in the plurality of physical root sequence numbers each correspond to a same cubic metric interval, a same maximum round-trip time interval, and a same maximum Doppler frequency shift interval; and
setting a logical root sequence number for each sorted physical root sequence number, to obtain a mapping relationship between the logical root sequence number and the physical root sequence number, wherein the logical root sequence number is a position index of the corresponding physical root sequence number in the plurality of physical root sequence numbers.

3. The method according to claim 1, wherein the method further comprises:
receiving indication information, wherein the indication information indicates the first logical root sequence number, and the first logical root sequence number indicates a sequence number of the first physical root sequence.

4. The method according to claim 1, wherein a plurality of physical root sequence numbers are divided into a plurality of physical root sequence number sets, and the plurality of physical root sequence number sets are obtained according to the following division rule:
dividing the plurality of physical root sequence numbers into a low cubic metric group and a high cubic metric group by using a first cubic metric as a boundary, wherein cubic metrics of physical root sequences indicated by physical root sequence numbers in the low cubic metric group do not exceed the first cubic metric, and cubic metrics of physical root sequences indicated by physical root sequence numbers in the high cubic metric group exceed the first cubic metric;
for the low cubic metric group and the high cubic metric group, dividing physical root sequence numbers in each group into a plurality of physical root sequence number sets by using a maximum round-trip time and a maximum Doppler frequency shift as a boundary; and
arranging physical root sequence numbers in each of the plurality of physical root sequence number sets in a cubic metric order.

5. The method according to claim 4, wherein the method further comprises:
determining a candidate peak point of an ambiguity function of a physical root sequence corresponding to each physical root sequence number, wherein in a delay-Doppler coordinate system, the candidate peak point satisfies at least one of the following:
a delay spacing between the candidate peak point and a coordinate origin in the delay-Doppler coordinate system is not greater than a delay spacing between the coordinate origin and any peak point other than the coordinate origin;
a Doppler spacing between the candidate peak point and the coordinate origin in the delay-Doppler coordinate system is not greater than a Doppler spacing between the coordinate origin and the any peak point other than the coordinate origin; or
a horizontal axis in the delay-Doppler coordinate system indicates delay domain, and a vertical axis in the delay-Doppler coordinate system indicates Doppler domain.

6. The method according to claim 5, wherein a set [symbol] ={ [symbol] , [symbol] , . . . , [symbol] } of coordinates of candidate peak points of the ambiguity function satisfies the following:
$$𝒮 = \{ 〈 τ , u τ mod N 〉 \vert min \{ \pm u τ mod N \} < {min}_{n = 1 , 2 , … , τ - 1} \{ \pm un mod N \} , τ ∈ \{ 1 , 2 , … , ( N - 1 ) / 2 \} \}$$
wherein N indicates a sequence length of the first physical root sequence, u indicates the first physical root sequence number, τᵢ indicates a delay coordinate of an i^{th} candidate peak point in the set S of the coordinates of the candidate peak points of the ambiguity function, vᵢ indicates a Doppler coordinate of the i^{th} candidate peak point in the set [symbol] of the coordinates of the candidate peak points of the ambiguity function, a value range of i is 0≤i≤| [symbol] |−1, and the operator |·| indicates cardinality of the set.

7. The method according to claim 6, wherein the method further comprises:
determining an i^{th} candidate physical root sequence number set Δ_{T,k}_{ᵢ}×Δ_{F,l}_{ᵢ} based on coordinates [symbol] of the i^{th} candidate peak point in the set S, wherein a maximum round-trip time interval [Δ_{T,k}_{ᵢ}, Δ_{T,k}_{ᵢ}₊₁) and a maximum Doppler frequency shift interval [Δ_{F,l}_{ᵢ}, Δ_{F,l}_{ᵢ}₊₁) that correspond to Δ_{T,k}_{ᵢ}×Δ_{F,l}_{ᵢ} satisfy the following:
$${τ}_{i} \times min \{ {v}_{i} , N - {v}_{i} \} ∈ [ {Δ}_{T , {k}_{i}} , {Δ}_{T , {k}_{i} + 1} ) \times [ {Δ}_{F , {l}_{i}} , {Δ}_{F , {l}_{i} + 1} ) ,$$
wherein
[Δ_{T,0}, Δ_{T,1}), [Δ_{T,1}, Δ_{T,2}), . . . , [Δ_{T,K-1}, +∞) indicates K preset maximum round-trip time intervals in the physical root sequence number set, [Δ_{F,0}, Δ_{F,1}), [Δ_{F,1}, Δ_{F,2}), . . . , [Δ_{F,L-1}, +∞) indicates L preset maximum Doppler frequency shift intervals in the physical root sequence number set, 0≤kᵢ≤K−1, 0≤lᵢ≤L−1, and 0≤i≤| [symbol] |−1; and
determining, based on each candidate physical root sequence number set, a physical root sequence number set Δ_{T,k}, Δ_{T,k+1})×[Δ_{F,l}, Δ_{F,l+1}) corresponding to the physical root sequence number, wherein k∈{0,1, . . . K−1}, l∈={0,1, . . . L−1}.

8. The method according to claim 7, wherein when a quantity K of maximum round-trip delay intervals is equal to a quantity L of maximum Doppler frequency shift intervals, an arrangement order of the plurality of physical root sequence number sets satisfies the following:
K×L physical root sequence number sets are sorted in ascending order of max {k, l}, wherein
when max {k, l} are the same and are even numbers, k are sorted in ascending order, and for any k, l are sorted in descending order; or
when max {k, l} are the same and are odd numbers, l are sorted in ascending order, and for any l, k are sorted in descending order;
or
wherein when a quantity K of maximum round-trip delay intervals is equal to a quantity L of maximum Doppler frequency shift intervals, an arrangement order of the plurality of physical root sequence number sets satisfies the following:
K×L physical root sequence number sets are sorted in ascending order of max {k, l}, wherein
when max {k, l} are the same and are even numbers, l are sorted in ascending order, and for any l, k are sorted in descending order; or
when max {k, l} are the same and are odd numbers, k are sorted in ascending order, and for any k, l are sorted in descending order;
or
wherein an arrangement order of the plurality of physical root sequence number sets satisfies the following:
K×L physical root sequence number sets are sorted in ascending order of k, wherein
when k are the same and are even numbers, l are sorted in ascending order; or
when k are the same and are odd numbers, l are sorted in descending order;
or
wherein an arrangement order of the plurality of physical root sequence number sets satisfies the following:
K×L physical root sequence number sets are sorted in ascending order of l; and
when l are the same and are even numbers, k are sorted in ascending order; or
when l are the same and are odd numbers, k are sorted in descending order.

9. A communication method, comprising:
receiving a first sequence, wherein the first sequence is determined based on a first physical root sequence, the first physical root sequence belongs to a first physical root sequence set, and root sequences in the first physical root sequence set correspond to a same cubic metric interval, a same maximum round-trip time interval, and a same maximum Doppler frequency shift interval; and
determining the first sequence based on a first logical root sequence number and a mapping relationship between a logical root sequence number and a physical root sequence number, wherein the first logical root sequence number indicates the first physical root sequence.

10. The method according to claim 9, wherein the method further comprises:
sorting a plurality of physical root sequence numbers, wherein a plurality of consecutive physical root sequence numbers in the plurality of the physical root sequence numbers each correspond to a same cubic metric interval, a same maximum round-trip time interval, and a same maximum Doppler frequency shift interval; and
setting a logical root sequence number for each sorted physical root sequence number, to obtain a mapping relationship between the logical root sequence number and the physical root sequence number, wherein the logical root sequence number is a position index of the corresponding physical root sequence number in the plurality of the physical root sequence numbers.

11. The method according to claim 9, wherein the method further comprises:
sending indication information, wherein the indication information indicates the first logical root sequence number, and the first logical root sequence number indicates a sequence number of the first physical root sequence.

12. The method according to claim 9, wherein a plurality of physical root sequence numbers are divided into a plurality of physical root sequence number sets, and the plurality of physical root sequence number sets are obtained according to the following division rule:
dividing the plurality of physical root sequence numbers into a low cubic metric group and a high cubic metric group by using a first cubic metric as a boundary, wherein cubic metrics of physical root sequences indicated by physical root sequence numbers in the low cubic metric group do not exceed the first cubic metric, and cubic metrics of physical root sequences indicated by physical root sequence numbers in the high cubic metric group exceed the first cubic metric;
for the low cubic metric group and the high cubic metric group, dividing physical root sequence numbers in each group into a plurality of physical root sequence number sets by using a maximum round-trip time and a maximum Doppler frequency shift as a boundary; and
arranging physical root sequence numbers in each of the plurality of physical root sequence number sets in a cubic metric order.

13. The method according to claim 12, wherein the method further comprises:
determining a candidate peak point of an ambiguity function of a physical root sequence corresponding to each physical root sequence number, wherein in a delay-Doppler coordinate system, the candidate peak point satisfies at least one of the following:
a delay spacing between the candidate peak point and a coordinate origin in the delay-Doppler coordinate system is not greater than a delay spacing between the coordinate origin and any peak point other than the coordinate origin;
a Doppler spacing between the candidate peak point and the coordinate origin in the delay-Doppler coordinate system is not greater than a Doppler spacing between the coordinate origin and the any peak point other than the coordinate origin; or
a horizontal axis in the delay-Doppler coordinate system indicates delay domain, and a vertical axis in the delay-Doppler coordinate system indicates Doppler domain;
wherein a set [symbol] ={ [symbol] , [symbol] , . . . , [symbol] } of coordinates of candidate peak points of the ambiguity function satisfies the following:
$$𝒮 = \{ 〈 τ , u τ mod N 〉 \vert min \{ \pm u τ mod N \} < {min}_{n = 1 , 2 , … , τ - 1} \{ \pm un mod N \} , τ ∈ \{ 1 , 2 , … , ( N - 1 ) / 2 \} \}$$
wherein N indicates a sequence length of the first physical root sequence, u indicates the first physical root sequence number, τᵢ indicates a delay coordinate of an i^{th} candidate peak point in the set [symbol] of the coordinates of the candidate peak points of the ambiguity function, vᵢ indicates a Doppler coordinate of the i^{th} candidate peak point in the set [symbol] of the coordinates of the candidate peak points of the ambiguity function, a value range of i is 0≤i≤| [symbol] |−1, and the operator |·| indicates cardinality of the set.

14. The method according to claim 13, wherein the method further comprises:
determining an i^{th} candidate physical root sequence number set Δ_{T,k}_{ᵢ}×Δ_{F,l}_{ᵢ} based on coordinates [symbol] of the i^{th} candidate peak point in the set [symbol] , wherein a maximum round-trip time interval [Δ_{T,k}_{ᵢ}, Δ_{T,k}_{ᵢ}₊₁) and a maximum Doppler frequency shift interval [Δ_{F,l}_{ᵢ}, Δ_{F,l}_{ᵢ}₊₁) that correspond to Δ_{T,k}_{ᵢ}×Δ_{F,l}_{ᵢ} satisfy the following:
$${τ}_{i} \times min \{ {v}_{i} , N - {v}_{i} \} ∈ [ {Δ}_{T , {k}_{i}} , {Δ}_{T , {k}_{i} + 1} ) \times [ {Δ}_{F , {l}_{i}} , {Δ}_{F , {l}_{i} + 1} ) ,$$
wherein
[Δ_{T,0}, Δ_{T,1}), [Δ_{T,1}, Δ_{T,2}), . . . , [Δ_{T,K-1}, +∞) indicates K preset maximum round-trip time intervals in the physical root sequence number set, [Δ_{F,0}, Δ_{F,1}), [Δ_{F,1}, Δ_{F,2}), . . . , [Δ_{F,L-1}, +∞) indicates L preset maximum Doppler frequency shift intervals in the physical root sequence number set, 0≤kᵢ≤K−1, 0≤lᵢ≤L−1, and 0≤i≤| [symbol] |−1; and
determining, based on each candidate physical root sequence number set, a physical root sequence number set [Δ_{T,k}, Δ_{T,k+1})×[Δ_{F,1}, Δ_{F,l+1}) corresponding to the physical root sequence number, wherein k∈{0,1, . . . K−1}, l∈{0,1, . . . L−1}.

15. The method according to claim 14, wherein when a quantity K of maximum round-trip delay intervals is equal to a quantity L of maximum Doppler frequency shift intervals, an arrangement order of the plurality of physical root sequence number sets satisfies the following:
K×L physical root sequence number sets are sorted in ascending order of max {k, l}, wherein when max {k, l} are the same and are even numbers, k are sorted in ascending order, and for any k, l are sorted in descending order; or
when max {k, l} are the same and are odd numbers, I are sorted in ascending order, and for any l, k are sorted in descending order;
or
wherein when a quantity K of maximum round-trip delay intervals is equal to a quantity L of maximum Doppler frequency shift intervals, an arrangement order of the plurality of physical root sequence number sets satisfies the following:
K×L physical root sequence number sets are sorted in ascending order of max {k, l}, wherein when max {k, l} are the same and are even numbers, l are sorted in ascending order, and for any l, k are sorted in descending order; or
when max {k, l} are the same and are odd numbers, k are sorted in ascending order, and for any k, l are sorted in descending order;
or
wherein an arrangement order of the plurality of physical root sequence number sets satisfies the following:
K×L physical root sequence number sets are sorted in ascending order of k, wherein
when k are the same and are even numbers, l are sorted in ascending order; or
when k are the same and are odd numbers, l are sorted in descending order;
or
wherein an arrangement order of the plurality of physical root sequence number sets satisfies the following:
K×L physical root sequence number sets are sorted in ascending order of l; and
when l are the same and are even numbers, k are sorted in ascending order; or
when l are the same and are odd numbers, k are sorted in descending order.

16. A communication apparatus, comprising:
at least one processor; and
a non-transitory computer-readable medium including computer-executable instructions that, when executed by the at least one processor, cause the apparatus to perform operations that comprise:
determining a first physical root sequence based on a first logical root sequence number and a mapping relationship between a logical root sequence number and a physical root sequence number; and
sending a first sequence, wherein the first sequence is determined based on the first physical root sequence, the first physical root sequence belongs to a first physical root sequence set, and root sequences in the first physical root sequence set correspond to a same cubic metric interval, a same maximum round-trip time interval, and a same maximum Doppler frequency shift interval.

17. The communication apparatus according to claim 16, wherein the operations further comprise:
sorting a plurality of physical root sequence numbers, wherein a plurality of consecutive physical root sequence numbers in the plurality of physical root sequence numbers each correspond to a same cubic metric interval, a same maximum round-trip time interval, and a same maximum Doppler frequency shift interval; and
setting a logical root sequence number for each sorted physical root sequence number, to obtain a mapping relationship between the logical root sequence number and the physical root sequence number, wherein the logical root sequence number is a position index of the corresponding physical root sequence number in the plurality of physical root sequence numbers.

18. The communication apparatus according to claim 16, wherein the operations further comprise:
receiving indication information, wherein the indication information indicates the first logical root sequence number, and the first logical root sequence number indicates a sequence number of the first physical root sequence.

19. The communication apparatus according to claim 16, wherein a plurality of physical root sequence numbers are divided into a plurality of physical root sequence number sets, and the plurality of physical root sequence number sets are obtained according to the following division rule:
dividing the plurality of physical root sequence numbers into a low cubic metric group and a high cubic metric group by using a first cubic metric as a boundary, wherein cubic metrics of physical root sequences indicated by physical root sequence numbers in the low cubic metric group do not exceed the first cubic metric, and cubic metrics of physical root sequences indicated by physical root sequence numbers in the high cubic metric group exceed the first cubic metric;
for the low cubic metric group and the high cubic metric group, dividing physical root sequence numbers in each group into a plurality of physical root sequence number sets by using a maximum round-trip time and a maximum Doppler frequency shift as a boundary; and
arranging physical root sequence numbers in each of the plurality of physical root sequence number sets in a cubic metric order.

20. The communication apparatus according to claim 19, wherein the operations further comprise:
determining a candidate peak point of an ambiguity function of a physical root sequence corresponding to each physical root sequence number, wherein in a delay-Doppler coordinate system, the candidate peak point satisfies at least one of the following:
a delay spacing between the candidate peak point and a coordinate origin in the delay-Doppler coordinate system is not greater than a delay spacing between the coordinate origin and any peak point other than the coordinate origin;
a Doppler spacing between the candidate peak point and the coordinate origin in the delay-Doppler coordinate system is not greater than a Doppler spacing between the coordinate origin and the any peak point other than the coordinate origin; or
a horizontal axis in the delay-Doppler coordinate system indicates delay domain, and a vertical axis in the delay-Doppler coordinate system indicates Doppler domain.

21. The communication apparatus according to claim 20, wherein a set [symbol] ={ [symbol] , [symbol] , . . . , [symbol] } of coordinates of candidate peak points of the ambiguity function satisfies the following:
$$𝒮 = \{ 〈 τ , u τ mod N 〉 \vert min \{ \pm u τ mod N \} < {min}_{n = 1 , 2 , … , τ - 1} \{ \pm un mod N \} , τ ∈ \{ 1 , 2 , … , ( N - 1 ) / 2 \} \}$$
wherein N indicates a sequence length of the first physical root sequence, u indicates the first physical root sequence number, τᵢ indicates a delay coordinate of an i^{th} candidate peak point in the set [symbol] of the coordinates of the candidate peak points of the ambiguity function, vᵢ indicates a Doppler coordinate of the i^{th} candidate peak point in the set [symbol] of the coordinates of the candidate peak points of the ambiguity function, a value range of i is 0≤i≤| [symbol] |−1, and the operator |·| indicates cardinality of the set.

22. The communication apparatus according to claim 21, wherein the operations further comprise:
determining an i^{th} candidate physical root sequence number set Δ_{T,k}_{ᵢ}×Δ_{F,l}_{ᵢ} based on coordinates [symbol] of the i^{th} candidate peak point in the set [symbol] , wherein a maximum round-trip time interval [Δ_{T,k}_{ᵢ}, Δ_{T,k}_{ᵢ}₊₁) and a maximum Doppler frequency shift interval [Δ_{F,l}_{ᵢ}, Δ_{F,l}_{ᵢ}₊₁) that correspond to Δ_{T,k}_{ᵢ}×Δ_{F,l}_{ᵢ} satisfy the following:
$${τ}_{i} \times min \{ {v}_{i} , N - {v}_{i} \} ∈ [ {Δ}_{T , {k}_{i}} , {Δ}_{T , {k}_{i} + 1} ) \times [ {Δ}_{F , {l}_{i}} , {Δ}_{F , {l}_{i} + 1} ) ,$$
wherein
[Δ_{T,0}, Δ_{T,1}), [Δ_{T,1}, Δ_{T,2}), . . . , [Δ_{T,K-1}, +∞) indicates K preset maximum round-trip time intervals in the physical root sequence number set, [Δ_{F,0}, Δ_{F,1}), [Δ_{F,1}, Δ_{F,2}), . . . , [Δ_{F,L-1}, +∞) indicates L preset maximum Doppler frequency shift intervals in the physical root sequence number set, 0≤kᵢ≤K−1, 0≤lᵢ≤L−1, and 0≤i≤| [symbol] |−1; and
determining, based on each candidate physical root sequence number set, a physical root sequence number set [Δ_{T,k}, Δ_{T,k+1})×[Δ_{F,1}, Δ_{F,l+1}) corresponding to the physical root sequence number, wherein k∈{0,1, . . . K−1}, l∈{0,1, . . . L−1}.

23. The communication apparatus according to claim 22, wherein when a quantity K of maximum round-trip delay intervals is equal to a quantity L of maximum Doppler frequency shift intervals, an arrangement order of the plurality of physical root sequence number sets satisfies the following:
K×L physical root sequence number sets are sorted in ascending order of max {k, l}, wherein
when max {k, l} are the same and are even numbers, k are sorted in ascending order, and for any k, l are sorted in descending order; or
when max {k, l} are the same and are odd numbers, l are sorted in ascending order, and for any l, k are sorted in descending order;
or
wherein when a quantity K of maximum round-trip delay intervals is equal to a quantity L of maximum Doppler frequency shift intervals, an arrangement order of the plurality of physical root sequence number sets satisfies the following:
K×L physical root sequence number sets are sorted in ascending order of max {k, l}, wherein
when max {k, l} are the same and are even numbers, l are sorted in ascending order, and for any l, k are sorted in descending order; or
when max {k, l} are the same and are odd numbers, k are sorted in ascending order, and for any k, l are sorted in descending order;
or
wherein an arrangement order of the plurality of physical root sequence number sets satisfies the following:
K×L physical root sequence number sets are sorted in ascending order of k, wherein
when k are the same and are even numbers, l are sorted in ascending order; or
when k are the same and are odd numbers, l are sorted in descending order;
or
wherein an arrangement order of the plurality of physical root sequence number sets satisfies the following:
K×L physical root sequence number sets are sorted in ascending order of l; and
when l are the same and are even numbers, k are sorted in ascending order; or
when l are the same and are odd numbers, k are sorted in descending order.

24. A communication apparatus, comprising:
at least one processor; and
a non-transitory computer-readable medium including computer-executable instructions that, when executed by the at least one processor, cause the apparatus to perform operations that comprise:
receiving a first sequence, wherein the first sequence is determined based on a first physical root sequence, the first physical root sequence belongs to a first physical root sequence set, and root sequences in the first physical root sequence set correspond to a same cubic metric interval, a same maximum round-trip time interval, and a same maximum Doppler frequency shift interval; and
determining the first sequence based on a first logical root sequence number and a mapping relationship between a logical root sequence number and a physical root sequence number, wherein the first logical root sequence number indicates the first physical root sequence.

25. The communication apparatus according to claim 24, wherein the operations further comprise;
sorting a plurality of physical root sequence numbers, wherein a plurality of consecutive physical root sequence numbers in the plurality of physical root sequence numbers each correspond to a same cubic metric interval, a same maximum round-trip time interval, and a same maximum Doppler frequency shift interval; and
setting a logical root sequence number for each sorted physical root sequence number, to obtain a mapping relationship between the logical root sequence number and the physical root sequence number, wherein the logical root sequence number is a position index of the corresponding physical root sequence number in the plurality of physical root sequence numbers.

26. The communication apparatus according to claim 24, wherein the operations further comprise:
sending indication information, wherein the indication information indicates the first logical root sequence number, and the first logical root sequence number indicates a sequence number of the first physical root sequence.

27. The communication apparatus according to claim 24, wherein a plurality of physical root sequence numbers are divided into a plurality of physical root sequence number sets, and the plurality of physical root sequence number sets are obtained according to the following division rule:
dividing the plurality of physical root sequence numbers into a low cubic metric group and a high cubic metric group by using a first cubic metric as a boundary, wherein cubic metrics of physical root sequences indicated by physical root sequence numbers in the low cubic metric group do not exceed the first cubic metric, and cubic metrics of physical root sequences indicated by physical root sequence numbers in the high cubic metric group exceed the first cubic metric;
for the low cubic metric group and the high cubic metric group, dividing physical root sequence numbers in each group into a plurality of physical root sequence number sets by using a maximum round-trip time and a maximum Doppler frequency shift as a boundary; and
arranging physical root sequence numbers in each of the plurality of physical root sequence number sets in a cubic metric order.

28. The communication apparatus according to claim 27, wherein the operations further comprise:
determining a candidate peak point of an ambiguity function of a physical root sequence corresponding to each physical root sequence number, wherein in a delay-Doppler coordinate system, the candidate peak point satisfies at least one of the following:
a delay spacing between the candidate peak point and a coordinate origin in the delay-Doppler coordinate system is not greater than a delay spacing between the coordinate origin and any peak point other than the coordinate origin;
a Doppler spacing between the candidate peak point and the coordinate origin in the delay-Doppler coordinate system is not greater than a Doppler spacing between the coordinate origin and the any peak point other than the coordinate origin; or
a horizontal axis in the delay-Doppler coordinate system indicates delay domain, and a vertical axis in the delay-Doppler coordinate system indicates Doppler domain;
wherein a set [symbol] ={ [symbol] , [symbol] , . . . [symbol] } of coordinates of candidate peak points of the ambiguity function satisfies the following:
$$𝒮 = \{ 〈 τ , u τ mod N 〉 \vert min \{ \pm u τ mod N \} < {min}_{n = 1 , 2 , … , τ - 1} \{ \pm un mod N \} , τ ∈ \{ 1 , 2 , … , ( N - 1 ) / 2 \} \}$$
N indicates a sequence length of the first physical root sequence, u indicates the first physical root sequence number, τᵢ indicates a delay coordinate of an i^{th} candidate peak point in the set [symbol] of the coordinates of the candidate peak points of the ambiguity function, vᵢ indicates a Doppler coordinate of the i^{th} candidate peak point in the set [symbol] of the coordinates of the candidate peak points of the ambiguity function, a value range of i is 0≤i≤| [symbol] |−1, and the operator |·| indicates cardinality of the set.

29. The communication apparatus according to claim 28, wherein the operations further comprise:
determining an i^{th} candidate physical root sequence number set Δ_{T,k}_{ᵢ}×Δ_{F,l}_{ᵢ} based on coordinates [symbol] of the i^{th} candidate peak point in the set [symbol] , wherein a maximum round-trip time interval [Δ_{T,k}_{ᵢ}, Δ_{T,k}_{ᵢ}₊₁) and a maximum Doppler frequency shift interval [Δ_{F,l}_{ᵢ}, Δ_{F,l}_{ᵢ}₊₁) that correspond to Δ_{T,k}_{ᵢ}×Δ_{F,l}_{ᵢ} satisfy the following:
$${τ}_{i} \times min \{ {v}_{i} , N - {v}_{i} \} ∈ [ {Δ}_{T , {k}_{i}} , {Δ}_{T , {k}_{i} + 1} ) \times [ {Δ}_{F , {l}_{i}} , {Δ}_{F , {l}_{i} + 1} ) ,$$
wherein
[Δ_{T,0}, Δ_{T,1}), [Δ_{T,1}, Δ_{T,2}), . . . , [Δ_{T,K-1}, +∞) indicates K preset maximum round-trip time intervals in the physical root sequence number set, [Δ_{F,0}, Δ_{F,1}), [Δ_{F,1}, Δ_{F,2}), . . . , [Δ_{F,L-1}, +∞) indicates L preset maximum Doppler frequency shift intervals in the physical root sequence number set, 0≤kᵢ≤K−1, 0≤lᵢ≤L−1, and 0≤i≤| [symbol] |−1; and
determining, based on each candidate physical root sequence number set, a physical root sequence number set [Δ_{T,k}, Δ_{T,k+1})×[Δ_{F,l}, Δ_{F,l+1}) corresponding to the physical root sequence number, wherein k∈{0,1, . . . K−1}, l∈{0,1, . . . L−1}.

30. The communication apparatus according to claim 29, wherein when a quantity K of maximum round-trip delay intervals is equal to a quantity L of maximum Doppler frequency shift intervals, an arrangement order of the plurality of physical root sequence number sets satisfies the following:
K×L physical root sequence number sets are sorted in ascending order of max {k, l}, wherein
when max {k, l} are the same and are even numbers, k are sorted in ascending order, and for any k, l are sorted in descending order; or
when max {k, l} are the same and are odd numbers, I are sorted in ascending order, and for any l, k are sorted in descending order;
or
wherein when a quantity K of maximum round-trip delay intervals is equal to a quantity L of maximum Doppler frequency shift intervals, an arrangement order of the plurality of physical root sequence number sets satisfies the following:
K×L physical root sequence number sets are sorted in ascending order of max {k, l}, wherein
when max {k, l} are the same and are even numbers, l are sorted in ascending order, and for any l, k are sorted in descending order; or
when max {k, l} are the same and are odd numbers, k are sorted in ascending order, and for any k, l are sorted in descending order;
or
wherein an arrangement order of the plurality of physical root sequence number sets satisfies the following:
K×L physical root sequence number sets are sorted in ascending order of k, wherein
when k are the same and are even numbers, l are sorted in ascending order; or
when k are the same and are odd numbers, l are sorted in descending order;
or
wherein an arrangement order of the plurality of physical root sequence number sets satisfies the following:
K×L physical root sequence number sets are sorted in ascending order of l; and
when l are the same and are even numbers, k are sorted in ascending order; or
when l are the same and are odd numbers, k are sorted in descending order.
